(19) United States
(12) Patent Application Publication
(10) Pub. No.: US 2020/0154943 A1
(43) Pub. Date: May 21, 2020

(54) IMAGING SYSTEM FOR COOKING DEVICE

(71) Applicant: GMG Products LLC, Lakeside, OR (US)

(72) Inventor: David W. Baker, Lakeside, OR (US)

(21) Appl. No.: 16/193,622

(22) Filed: Nov. 16, 2018

(51) Int. Cl. A47J 36/32; A23L 5/10; A47J 37/07; H04N 7/18

(52) U.S. Cl. CPC A47J 36/321; A23L 5/15; A23V 2002/00; H04N 7/185; A47J 37/0786

(57) ABSTRACT

A camera mechanism may be mounted adjacent to an aperture in a grill. The aperture may be covered with a movable aperture cover. The camera mechanism may have a camera with a camera lens that may be inserted through the aperture so as to physically contact the movable aperture cover and move the movable aperture cover out of the way so that the camera lens has an unobstructed view of the food items cooking in the cooking chamber. After taking pictures and/or videos of the food items, the camera mechanism may transmit the pictures and/or videos to a client device so the user may see the food items cooking in the grill in real-time. After taking the pictures and/or videos, the camera lens may be removed from the cooking chamber through the aperture allowing the movable aperture cover to again cover the aperture in the grill. In other embodiments, the aperture may always be open, i.e., no aperture cover, or the aperture may be covered by a transparent aperture cover to facilitate taking pictures and videos of food items within the grill through the aperture.

### FIELD OF THE INVENTION

The present invention generally relates to using an imaging system to remotely view a food item cooking in a cooking device, preferably in real-time.

### SUMMARY OF THE INVENTION

The present invention provides systems and methods for receiving pictures/videos in real time from a camera mechanism mounted on a cooking device as food items are cooking within the cooking device. The cooking device may be any type of desired cooking device. As non-limiting examples, the cooking device may an air fryer, grill, oven, brazier, steamer, roaster, fryer, broiler, stove or toaster oven. While the cooking device may be any type of cooking device, the present invention will be described with continuing reference to a grill. Those of ordinary skill in the art will be able to apply the present invention to other types of cooking devices using the description of the present invention in the specific non-limiting example of a grill.

The grill may have a cooking chamber configured to receive and cook food items. The grill may also have a heat source configured to adjust the temperature within the cooking chamber. The grill may also have an aperture through the cooking chamber of the grill. The aperture may be left open, covered by a transparent aperture cover or covered by a movable aperture cover.

In the embodiment using the movable aperture cover, the movable aperture cover may be pivotally mounted to the inside of the cooking chamber. The movable aperture cover may be in a closed position which thermally seals the cooking chamber or in an open position that allows a camera lens to be inserted into the cooking chamber to have an unobstructed view of the food items being cooked.

A camera mechanism may be mounted on the grill. The camera mechanism may have a camera bracket for retaining a camera with a camera lens, an electrical motor for moving the camera lens in and out of the cooking chamber of the grill and a control unit. The control unit may comprise a transceiver for receiving and sending electronic communications and control logic for implementing the functions of the camera mechanism. When a picture or video is requested the camera mechanism may insert the camera lens into the cooking chamber, take the requested pictures/videos, transmit the pictures/videos to the client device of the user and remove the camera lens from within the cooking chamber.

The above features and advantages of the present invention will be better understood from the following detailed description taken in conjunction with the accompanying drawings.

### BRIEF DESCRIPTION OF THE DRAWINGS

FIG. 1 is an illustration of a grill and a camera mechanism attached to the grill.

FIG. 2 is an illustration of a portion of a grill with a camera mechanism attached to the grill with a camera lens positioned close to an aperture in the grill. The aperture is covered by a transparent aperture cover so that the camera lens has a view of the food items cooking in the grill through the transparent aperture cover.

FIG. 3 is an illustration of a portion of a grill with a camera mechanism attached to the grill with a camera lens position close to an aperture and outside the grill with the aperture cover in a closed position.

FIG. 4 is an illustration of a portion of a grill with the camera lens pushed forward by an electric motor through the aperture and moving the aperture cover so that the camera lens is inside the grill with the aperture cover in an open position. This gives the camera lens an unobstructed view of the food items cooking in the grill.

FIG. 5 is an illustration of the inside of a portion of a grill showing how the insertion of the camera lens through the aperture by a motor may also be used to simultaneously move the aperture from a closed position to an open position.

FIG. 6 is an illustration of an example camera mechanism.

FIG. 7 is an illustration of an example camera mechanism.

FIG. 8 is an illustration of a camera bracket that may be used to hold a camera and/or camera lens.

FIG. 9 is an illustration of a spur gear having spur gear teeth which may be part of a camera bracket and rotated by a motor to move a camera lens between a position outside of the grill and a position inside of the grill.

FIG. 10 is an illustration of a rack having rack teeth which may be part of a camera bracket and moved linearly by the spur gear and motor so as to move the camera lens between a position outside of the grill and a position inside of the grill.

FIG. 11 is an illustration of a client device communicating directly with a camera mechanism, such as by using the Bluetooth protocol.

FIG. 12 is an illustration of a client device communicating via a local area network with a camera mechanism.

FIG. 13 is an illustration of a client device communicating via the Internet with a camera mechanism.

FIG. 14 is a flowchart of a method of a cook viewing food items on a client device being cooked in a grill in real-time with a movable camera lens and a movable aperture cover.

FIG. 15 is a flowchart of a method of a cook viewing food items on a client device where a camera lens is able to view the food items in the grill through a transparent aperture cover.

FIG. 16 is a diagram showing the transfer of information between a client device and a camera mechanism.

FIG. 17 is a diagram showing the transfer of information between a client device, Local Area Network (LAN) and camera mechanism.

FIG. 18 is a diagram showing the transfer of information between a client device, Internet and camera mechanism.

FIG. 19 is a diagram showing the transfer of information between a client device, Internet, LAN or Wi-Fi and camera mechanism.

FIG. 20 is a flowchart of a method of a cook viewing food items being cooked in a cooking chamber on a client device that also protects a camera mechanism from damage.

FIG. 21 is an example of a splash screen which may be part of an application loaded on the client device and displayed on the client device for use by the user.

FIGS. 22-30 are example screens which may be part of the application loaded on the client device and displayed and used to assist the user in connecting the imaging device (camera) and the client device (cell phone or computer) of the user to a WiFi network.

FIGS. 31-33 are example screens which may be part of the application loaded on the client device which may be used to assist the user after the WiFi connections for the imaging device and the client device have been established.

FIGS. 34-38 are example screens which may be part of the application loaded on the client device and used to take and view one or more photographs and/or videos of the inside the grill.

FIGS. 39-42 are example screens which may be part of the application loaded on the client device and used to periodically take one or more photographs and/or videos of the inside of the grill.

FIG. 43 is an example of an about application screen which may be part of the application loaded on the client device and used to inform the user about the use of the present invention.

FIG. 44 is an example support page which may be part of the application loaded on the client device and used to inform the user about support matters, such as online resources that may be referenced on the Internet.

FIGS. 45-49 are example screens which may be part of the application loaded on the client device and used by the user to connect to a server.

FIG. 50 is a block diagram of the cooking device operably coupled with a remote server, according to some examples.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

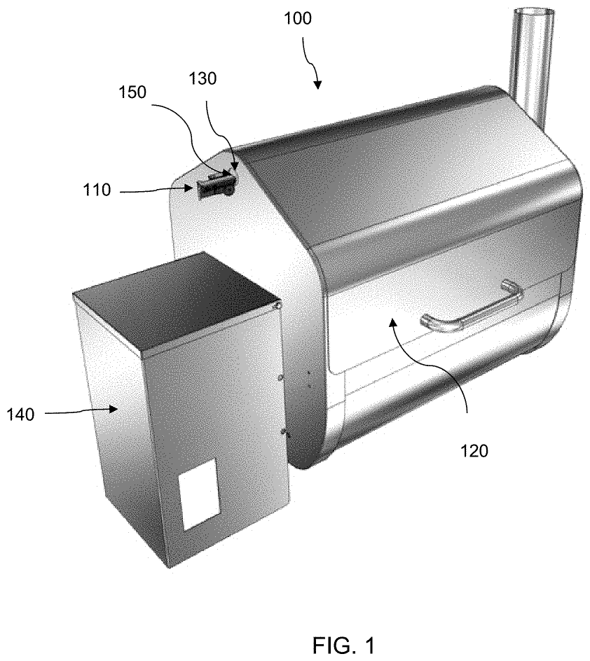

With reference to FIG. 1, a perspective view of an example cooking device 100 with an attached or mounted camera mechanism 110 is illustrated. The cooking device may be any type of desired cooking device. As non-limiting examples, the cooking device may an air fryer, grill, oven, brazier, steamer, roaster, fryer, broiler, stove or toaster oven. While the cooking device may be any type of cooking device, the present invention will be described with continuing reference to a grill 100. Those of ordinary skill in the art will be able to apply the present invention to other types of cooking devices 100 using the description of the present invention in the non-limiting example of a grill 100,

The grill 100 may use any desired fuel for heating the grill 100. As non-limiting examples, the heat source 140 for the grill 100 may be a pellet, wood, charcoal, stick burner, natural gas or gas. The heat source 140 is preferably sufficient to sustain a temperature inside the grill 100 of around 350 to 500 degrees Fahrenheit for cooking the food items. In some embodiments, the grill 100 may be able to automatically (without human intervention) regulate the temperature inside the cooking grill 100 to a predetermined set temperature. The heat source 140 may also be sufficient to heat the cooking chamber 120 inside the grill 100 to even higher temperatures to thermally clean the inside of the grill 100.

The grill 100 may also be made of any desired heat resistant material(s). As non-limiting examples, the grill 100 may be made of stainless steel (austenitic or ferritic), sheet steel and/or cast iron. The grill 100 is shaped to have an enclosed inner chamber, i.e., a cooking chamber 120, which may be heated by the heat source 140. The cooking chamber 120 may receive the food items through a lid which may be raised (opening the cooking chamber 120) and lowered (closing the cooking chamber 120) and cook any desired food items, such as meats or vegetables.

The grill 100 may also have an opening, i.e., an aperture 130, through the cooking chamber 120. While the aperture 130 may be any desired size, in preferred embodiments the aperture 130 is made as small as possible. Also, the aperture 130 may be any desired shape, such as, as non-limiting examples, a circle or a rectangle. In general, the aperture 130 is preferably less than three inches in diameter or three inches to a side.

The present invention encompasses three different embodiments for the aperture 130. In the first embodiment, the aperture 130 is continually left uncovered so that the aperture 130 may act as a viewing port, thereby allowing a camera lens 150 of a camera 210 to have an unobstructed view of the food items cooking in the cooking chamber 120. This embodiment has the advantage that it requires the fewest parts and is the simplest to build and use. However, this embodiment may allow heat to escape from the cooking chamber 120 through the aperture 130, thereby requiring more fuel to be burned by the heat source 140. This embodiment also allows heat passing through the aperture 130 to come in close contact with the camera lens 150 when camera lens 150 is positioned outside cooking chamber 120, which may damage or shorten the life of the camera lens 150 or allow the camera lens 150 to become dirty.

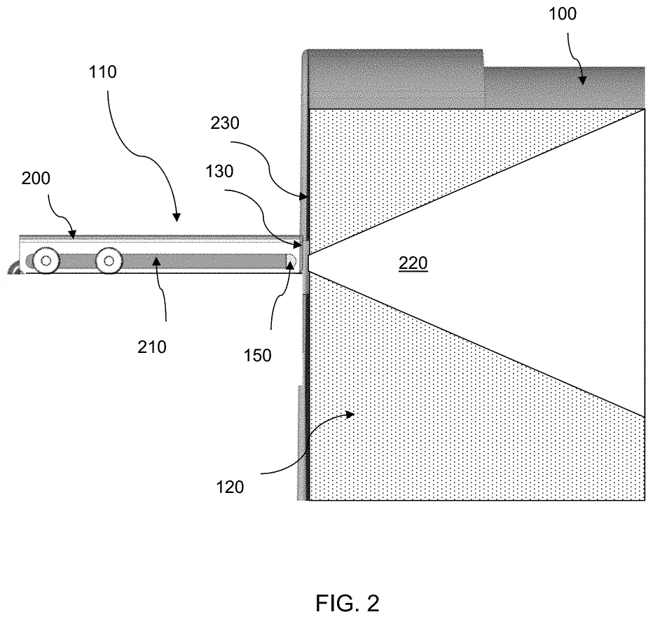

A second embodiment is illustrated in FIG. 2. This illustration is a side view of a non-moving camera mechanism 110 mounted to the outside of the grill 100. Only a portion of the grill 100 and the cooking chamber 120 are shown in this illustration. In this embodiment, the aperture 130 is covered by a transparent aperture cover 230. The transparent aperture cover 230 may be made of glass or any other transparent heat resistant material. This embodiment is relatively simple to build and use and has the advantages of keeping the cooking chamber 120 thermally closed and protecting the camera lens 150. However, this embodiment has the disadvantage of placing an obstacle (the transparent aperture cover 230) between the camera lens 150 and the food items. Further, the transparent aperture cover 230 is likely to get dirty from either smoke or food particles coming off of the food items while being cooked. A dirty transparent aperture cover 230 may reduce the quality of any pictures/videos taken of the food items cooking in the cooking chamber 120.

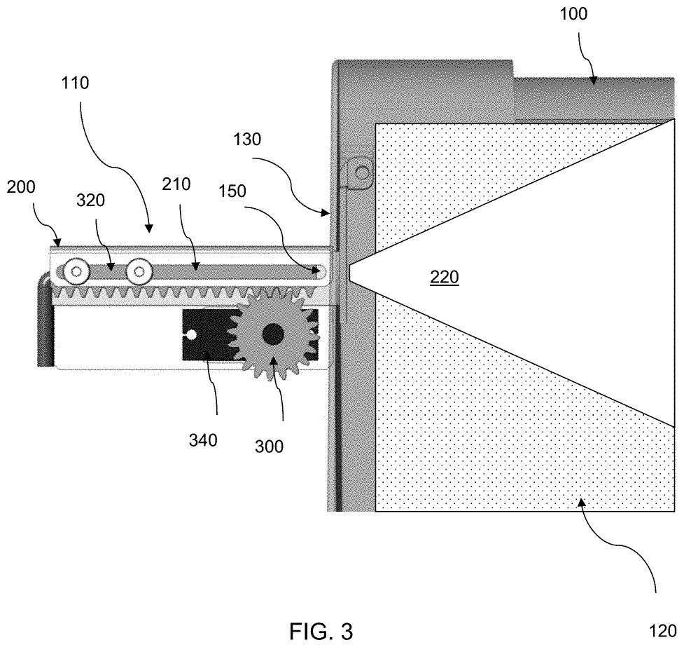

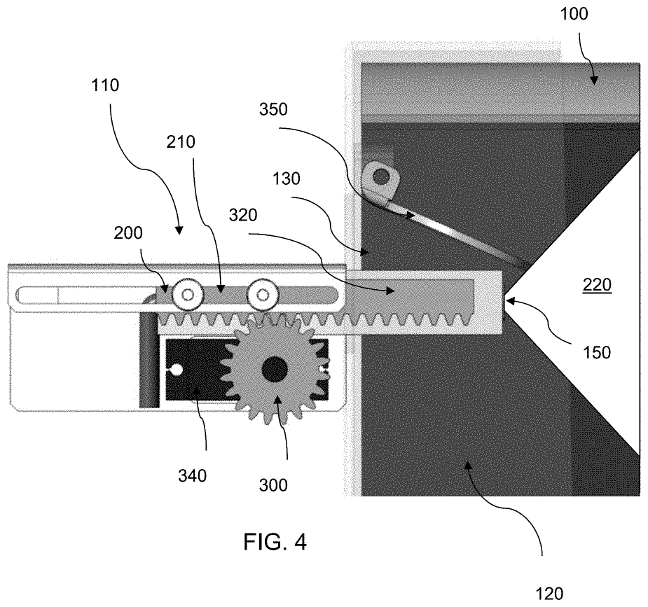

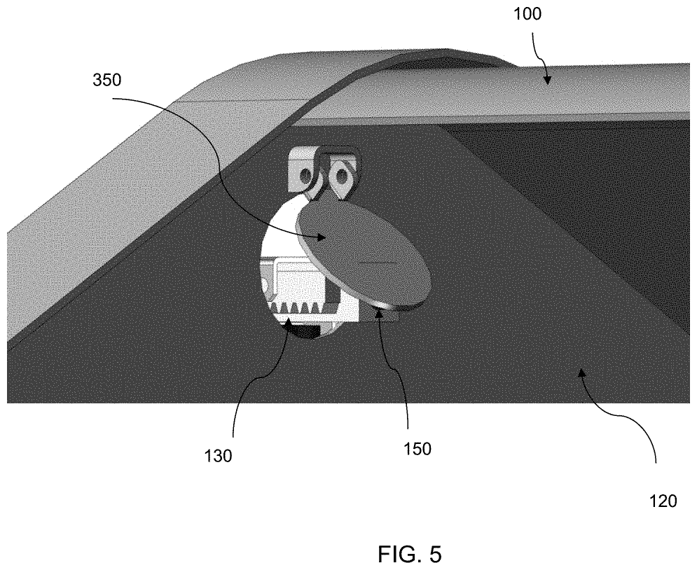

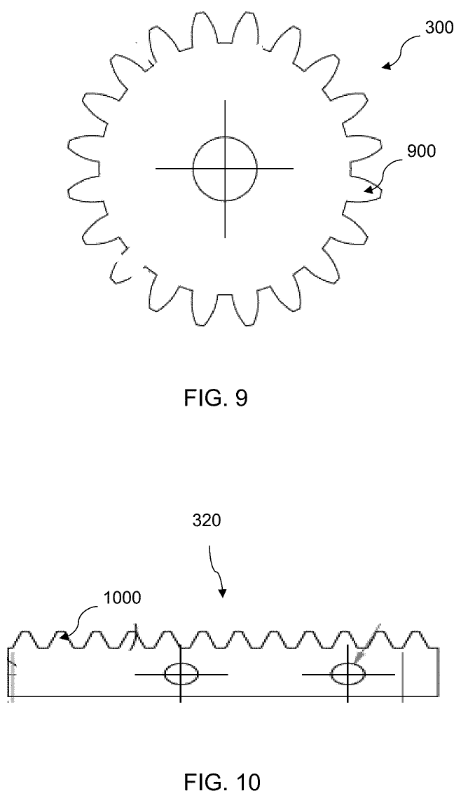

A third embodiment is illustrated in FIGS. 3-7, 9 and 10. FIG. 3 is a side view of a movable camera mechanism 110 mounted to the outside of grill 100, with the camera lens 150 being in a retracted/withdrawn position outside of the grill 100. Only a portion of the grill 100 and the cooking chamber 120 are shown in FIG. 3. FIG. 4 is a side view of a movable camera mechanism 110 mounted to the outside of the grill 100, with the camera lens 150 being in an extended/forward position inside of the grill 100. Only a portion of the grill 100 and the cooking chamber 120 are shown in FIG. 4. FIG. 5 is a perspective view of a movable camera mechanism 110 mounted on the outside of the grill 100, with the camera lens 150 in an intermediate position. The intermediate position of the camera lens 150 may occur during either the insertion of the camera lens 150 into the grill 100 or the withdrawal of the camera lens 150 from the grill 100. Only a portion of the grill 100 and the cooking chamber 120 are shown in FIG. 5.

In this embodiment, the aperture 130 is covered by a movable aperture cover 350. The movable aperture cover 350 does not need to be transparent and may be made of any thermally resistant material, such as, as non-limiting examples, stainless steel, sheet steel or cast iron. In this embodiment, the movable aperture cover 350 may be moved out of the way so that the camera lens 150 has an unobstructed view of the food items in the cooking chamber 120 through the aperture 130.

In a preferred embodiment, the camera lens 150 may be inserted into the cooking chamber 120 during the taking of pictures/videos of the food items while the food items are cooking in real-time. After the pictures/video of the food items are taken, the camera lens 150 may be withdrawn from the cooking chamber 120 and the movable aperture cover 350 may be positioned to cover the aperture 130. Any desired method of biasing the movable aperture cover 350 against the aperture 130 may be used. As non-limiting examples, the movable aperture cover 350 may be held against the aperture 130 by gravity or by springs. In a preferred embodiment, the movable aperture cover 350 is pivotally connected to the cooking chamber 120 and arranged so that gravity pulls the movable aperture cover 350 down and against the aperture 120.

Thus, the movable aperture cover 350 is preferably able to be moved between a closed position, which protects the thermal integrity of the cooking chamber 120 and thermally isolates the camera mechanism 110 from the cooking chamber 120, and an open position, which allows the camera 210 to take unobstructed pictures/videos of the food items in real-time, either from being positioned adjacent, but outside the cooking chamber 120 or by being inserted into the cooking chamber 120, while the food items are cooking.

In a preferred embodiment as illustrated in FIGS. 4 and 5, the movable aperture cover 350 is pivotally mounted on the inside of the grill 100 in the cooking chamber 120 so that as the camera lens 150 is inserted into the cooking chamber 120, the camera lens 150 physically contacts and moves the aperture cover from the closed position covering the aperture 130 to the open position not covering the aperture 130. In addition, after the pictures/videos have been taken, the aperture cover may move from the open position to the closed position as the camera lens 150 is withdrawn from the cooking chamber 120.

Referring to FIG. 2, an example camera mechanism 110 is illustrated that may be mounted on the grill 100. In this embodiment, the camera 210 and camera lens 150 are stationary and are able to take pictures/videos through an open aperture 130 or a transparent aperture cover 230 as previously described. An example field of view 220 of the camera lens 150 is illustrated in FIGS. 2-4.

Referring to FIGS. 3-7, an example camera mechanism 110 is illustrated that may be mounted on the grill 100. In this embodiment, the camera lens 150 may be inserted through an aperture 130 in the grill 100, thereby moving an aperture cover from a closed position to an open position and providing the camera lens 150 an unobstructed view of the food items cooking in the cooking chamber 120. The aperture cover is in a closed position in FIG. 3 while the aperture cover is in an open position in FIGS. 4 and 5.

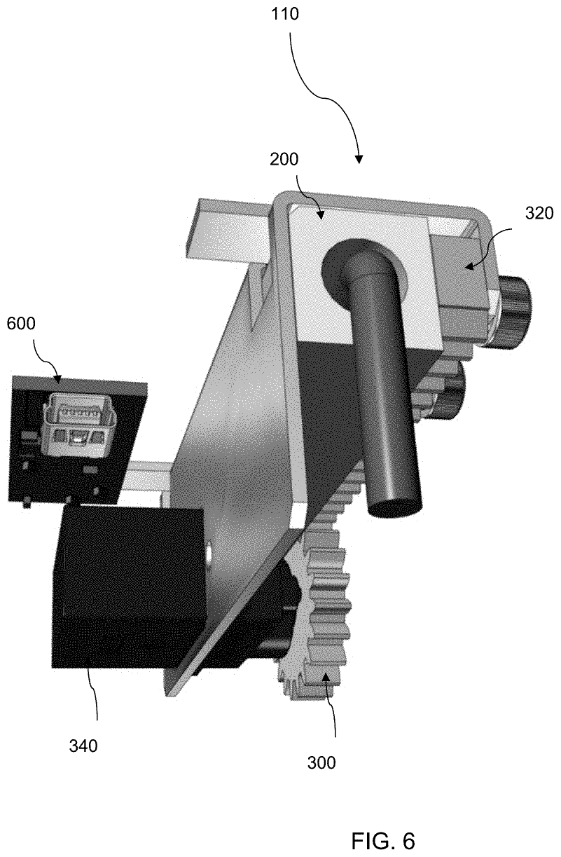

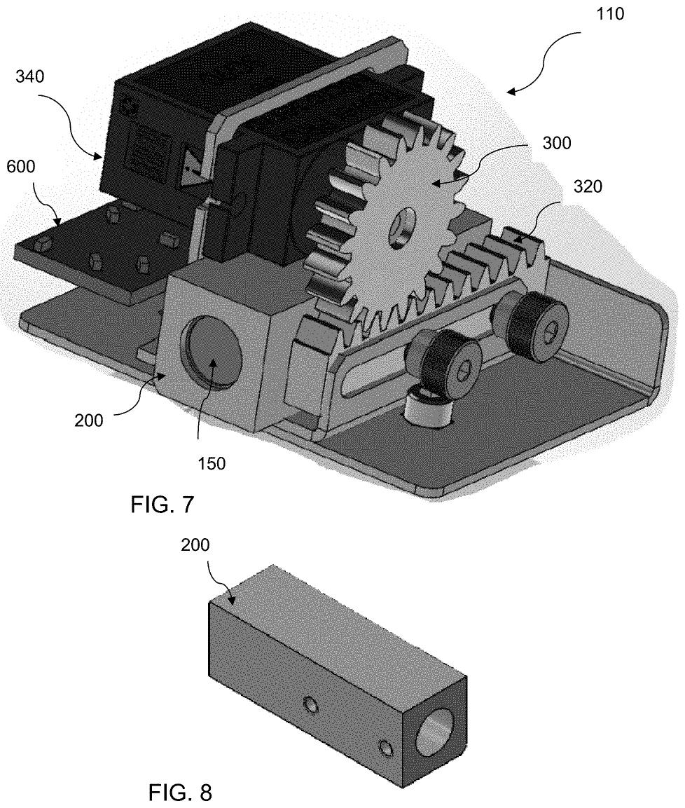

While any desired camera mechanism 110 may be used, in preferred embodiments, the camera 210 and/or the camera lens 150 are mounted to a camera bracket 200. The camera bracket 200, as illustrated in FIGS. 3, 4, 6 and 7, may be mounted to a rack 320. FIG. 6 is a perspective view of an example camera mechanism. FIG. 7 is a perspective view from the bottom of the example camera mechanism. A non-limiting example of a rack 320 is illustrated in FIG. 10. The teeth 1000 of the rack 320 may be positioned adjacent the teeth 900 of a spur gear 300, as illustrated in FIGS. 3, 4, 6 and 7. The spur gear 300 may also be part of the camera mechanism 110 and be attached, possibly via other gears, to an electrical motor 340. The electrical motor 340 may be controlled to be turned on or off by a control unit 600. An example control unit 600 is illustrated in FIGS. 6 and 7. The control unit 600 may have a wireless transceiver and computer logic. The control unit 600 may be configured to receive commands from a client device 1100, transmit commands to the electronic motor 340, transmit data to the client device 1100, receive a still picture or a video from the camera 210 and transmit the picture/video to the client device 1100. The client device 1100 may be, as non-limiting examples, a cell phone, tablet, laptop or desktop computer. The client device 1100 may be in communication with the camera mechanism 110 by any desired means.

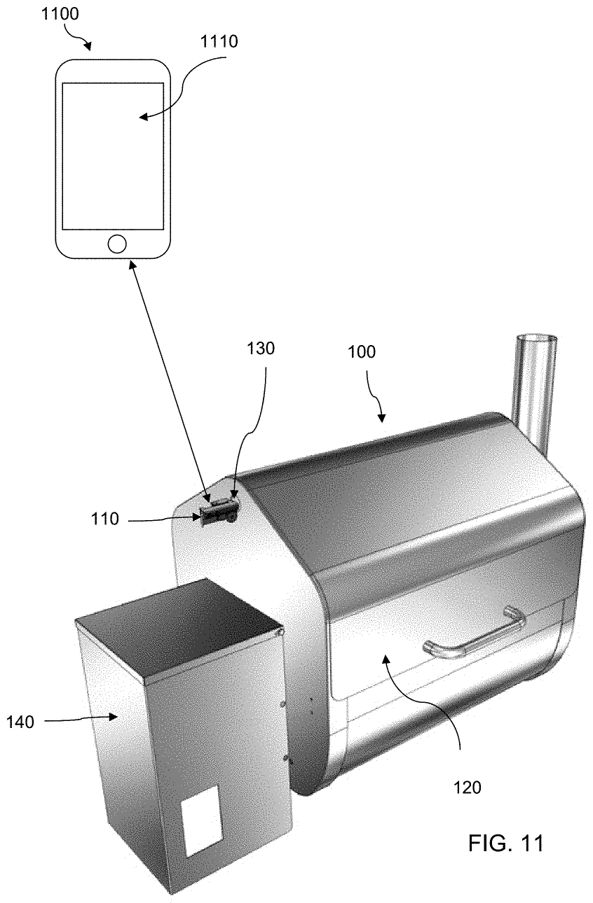

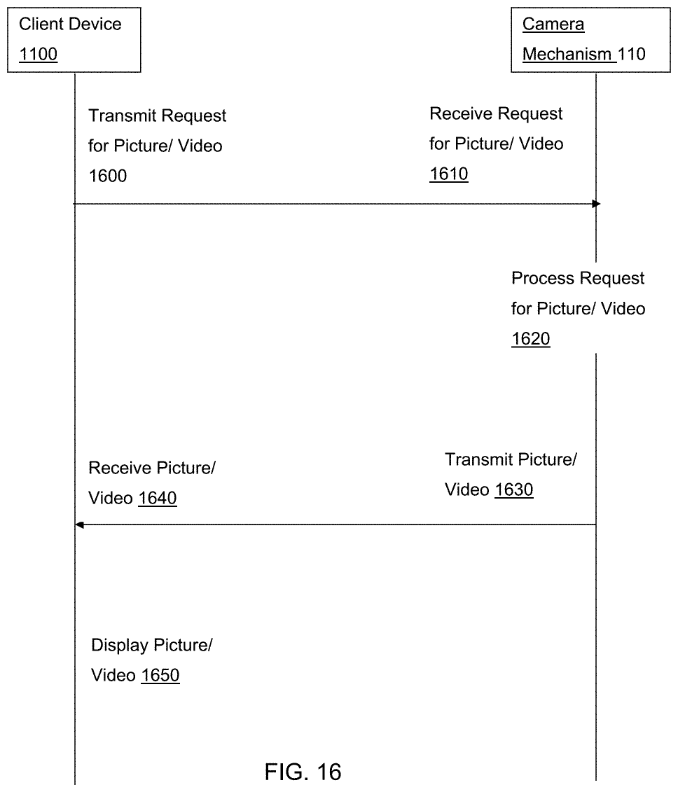

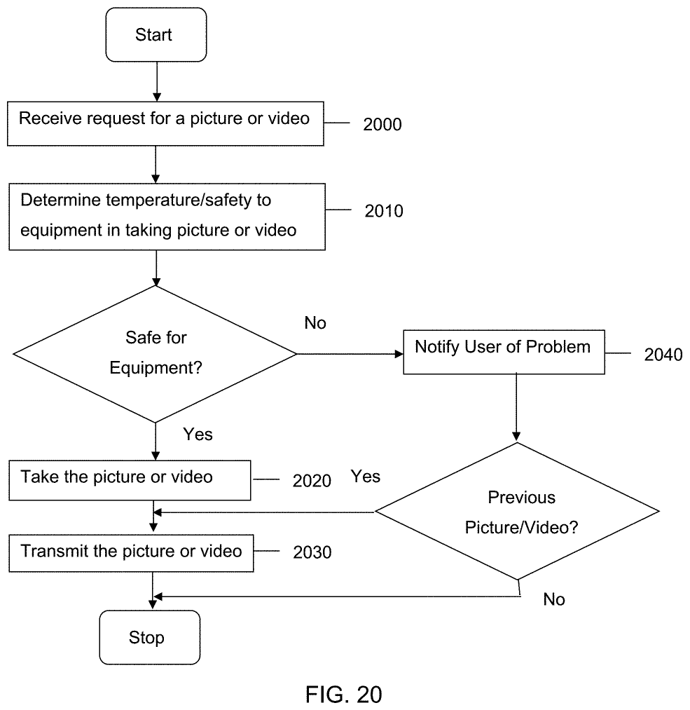

Another embodiment of the invention is illustrated in the flowchart of FIG. 20. With reference to FIGS. 11 and 16, the client device 1100 may be in communication with the camera mechanism 110 directly, such as by using a short range protocol such as Bluetooth. In this example embodiment, the client device 1100 may transmit a request for a picture or video directly to the camera mechanism 110. (Steps 1600) The camera mechanism 110 may receive the request from the client device 1100 (Step 1610) and process the request using a control unit 600 comprising computer logic (Step 1620). The computer logic, which may include computer software or firmware, may determine what course of action to take.

The camera mechanism 110 may determine it is safe for the camera lens 150 to be inserted into the cooking chamber 120, e.g., the camera lens 150 is not too hot, possibly as enough time has passed to cool the camera lens 150 or a thermometer has measured that the temperature of the camera lens 150 is within a safe range, and insert the camera lens into the cooking chamber 120. The safe operating temperature for the camera mechanism 110 and the camera lens 150 may be determined empirically.

The camera mechanism 110 may determine that the camera lens 150 is too hot or that it is unsafe to insert the camera lens 150 into the cooking chamber 120. In this event the camera mechanism 110 may send a notification back to the client device 1100 that it is unsafe to take a picture or video at this time and/or send the most recent picture or video taken with a notification to the client device 1100 that the transmitted picture or video is not in real-time and preferably display on the client device a time stamp or reference to how old the picture or video is.

In another embodiment, the camera mechanism 110 may periodically take pictures or video of the food items cooking in the cooking chamber 120 at a set interval. Any set interval may be used. As non-limiting examples, the camera mechanism 110 may be automatically taking pictures every 30 seconds, every minute, every 5 minutes or every 10 minutes. Thus, when a request for a new picture or video is received, the camera mechanism 110 may send the most recent picture or video of the food items cooking in the cooking chamber 120.

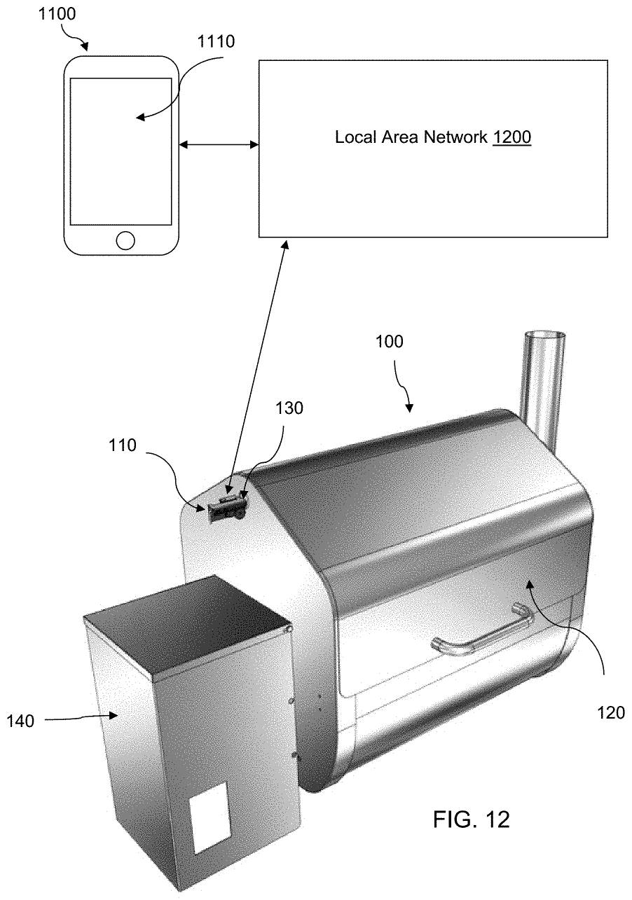

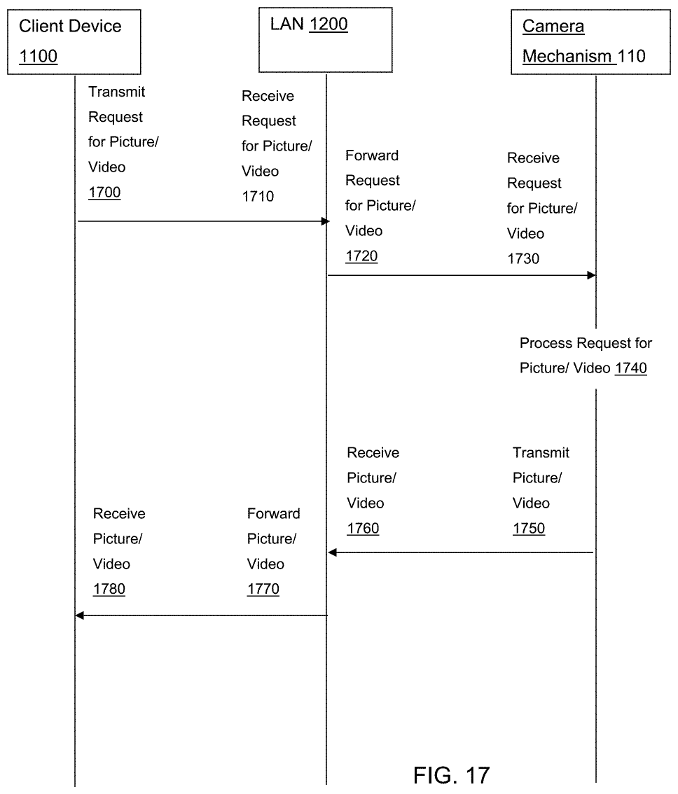

With reference to FIGS. 12 and 17, the client device 1100 may be in communication with the camera mechanism 110 through a local area network (LAN) 1200 (which could be a router or a Wi-Fi system). In this embodiment, the client device 1100 may transmit a request for a picture or video to the LAN 1700 (Steps 1700 and 1710), which forwards the request to the camera mechanism 110 (Steps 1720 and 1730). As previously described, the control unit 600 of the camera mechanism 110 may process the request and decide which action to take. (Step 1740). The camera mechanism 110 may transmit the picture or video the LAN 1700 (Steps 1750 and 1760), which forwards the picture or video to the client device 1100. The client device 1100 may display the picture or video to a user or cook on a display 1110 of the client device 1100.

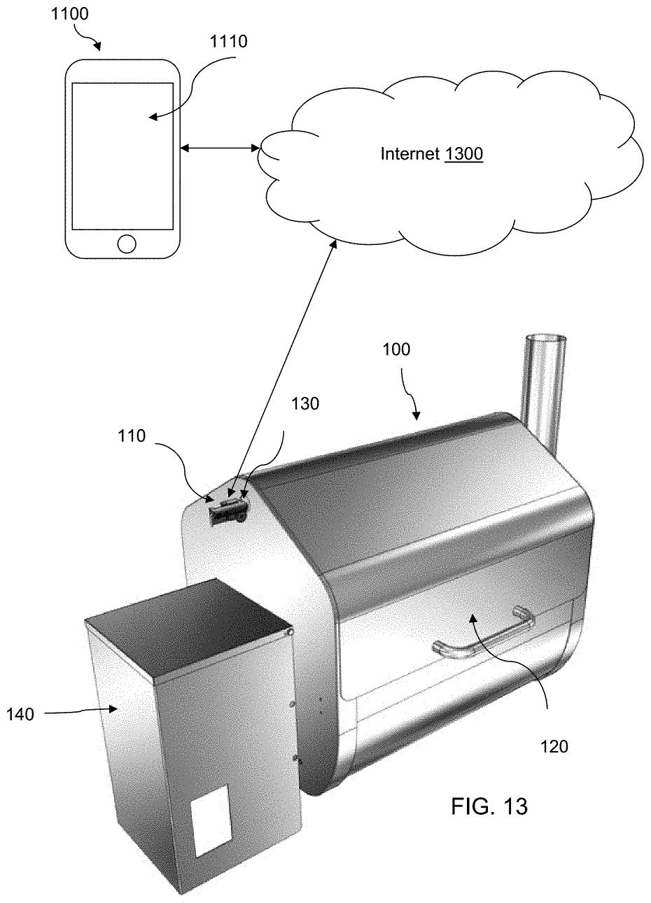

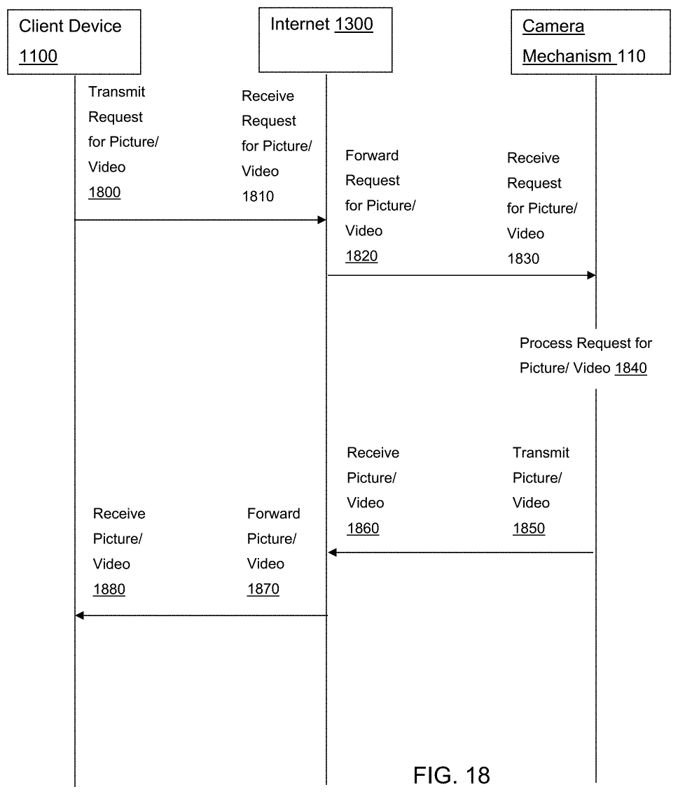

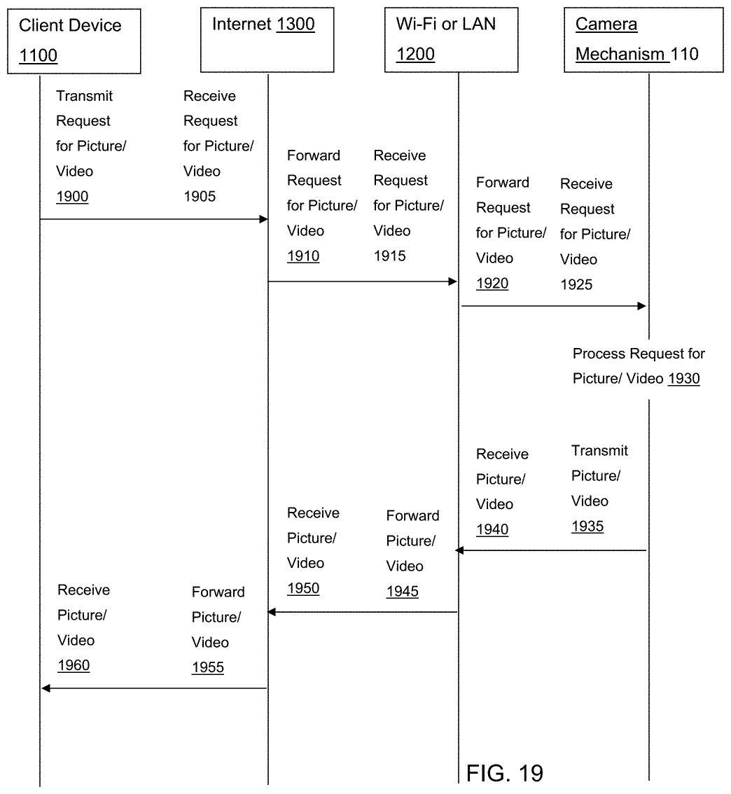

With reference to FIGS. 13 and 18, the client device 1100 may be in communication with the camera mechanism 110 through the Internet 1300. In this embodiment, the client device 1100 may transmit a request for a picture or video through the Internet 1300 (Steps 1800 and 1810), which forwards the request to the camera mechanism 110 (Steps 1820 and 1830). As previously described, the control unit 600 of the camera mechanism 110 may process the request and decide which action to take. (Step 1840). The camera mechanism 110 may transmit the picture or video through the Internet 1300 (Steps 1850 and 1860), which may forward the picture or video to the client device 1100. The client device 1100 may display the picture or video to a user or cook on a display 1110 of the client device 1100.

With reference to FIG. 19, the client device 1100 may be in communication with the camera mechanism 110 through the Internet 1300 and a LAN 1200. In this embodiment, the client device 1100 may transmit a request for a picture or video through the Internet 1300 (Steps 1900 and 1905), which forwards the request to a LAN 1200 (Steps 1910 and 1915), which forwards the request to the camera mechanism 110 (Steps 1920 and 1925). As previously described, the control unit 600 of the camera mechanism 110 may process the request and decide which action to take. (Step 1930) The camera mechanism 110 may transmit the picture or video through the LAN 1200 or Wi-Fi (Step 1935 and 1940), which may forward the picture or video through the Internet 1300 (Steps 1940 and 1950), which may forward the picture or video to the client device 1100. The client device 1100 may display the picture or video to a user or cook on a display 1110 of the client device 1100.

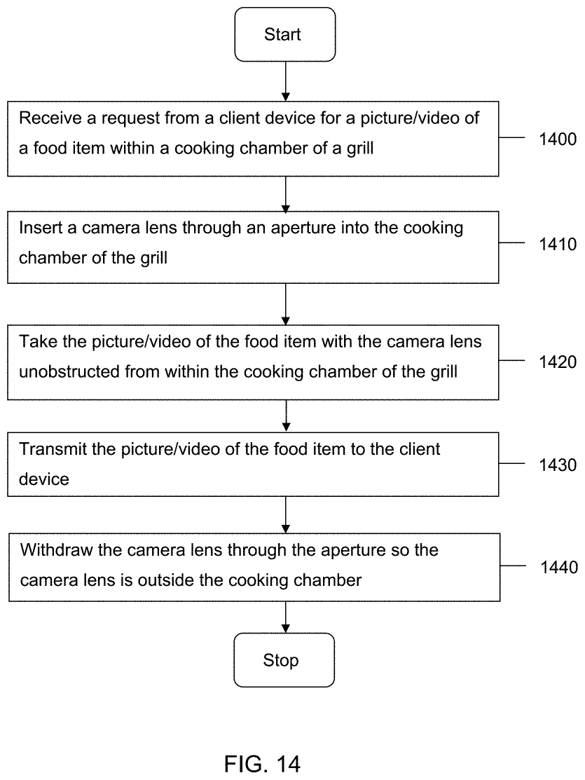

An example method of practicing the invention is shown in the flowchart in FIG. 14. A user, typically the cook, may start a grill 100 so as to heat the cooking chamber 120 to a desired temperature and place one or more food items, i.e., tasty foods, such as meats and/or vegetables into the cooking chamber 120. The user may not want to stay close to the grill 100, but still be able to view the food items in the cooking chamber 120 as the food items cook in real-time. Thus, the invention allows the user to stay in the house (possibly watching TV with friends, visiting a store, going on a bicycle ride, etc.) while still being able to visually monitor the food items as the food items cook in the cooking chamber 120. Thus, the user may remotely view the food items cooking in real-time, i.e., the user sees on the client device 1100 what the food items look like at the time the user is viewing the food items on the client device 1100. In other words, the user is not seeing what the food items looked like in the past, but what the food items currently look like. This real-time view helps the user in judging when to stop cooking the food items.

In some embodiments, a software application may be downloaded to the client device 1100 of the user. Using the application, the user may request a picture or video of the food items in the cooking chamber 120 while the food items are cooking in real-time. (Step 1400) The pictures/videos may be of any desired length or timing, although the system may prevent the camera lens 150 from being exposed for too long a period within the cooking chamber 120 or at too high a temperature, if the prolonged exposure or excessive temperature might damage the camera lens 150.

In one possible embodiment, the user, using the client device 1100 with a loaded software application, may request a current picture or a current video of the food items as the food items cook in real-time. In this embodiment, the user may select to view a real-time picture or video of the food items cooking in the cooking chamber 120 at any time selected by the user. This allows the user to focus, if desired, later in the cooking time so as to closely monitor exactly when the food items should be removed from the cooking chamber 120.

In another embodiment, the user may request that a picture or a short video of the food items be automatically sent to a display 1110 of the client device 1100 of the user in a predefined or selected time period, such as, as non-limiting examples, every 30 seconds, 1 minute, 30 minutes or hour. In this embodiment, the camera mechanism 110 may automatically (without further human intervention) take a picture or a video at the selected intervals and send the picture or video to the client device 1100 as a reminder to the user that the food items are still cooking and visually show the user what the food items look like at that point in the cooking process.

In another embodiment, a control unit 600 of the camera mechanism 110, once the control unit 600 of the camera mechanism 110 has been requested or determines a picture or video should be taken, may send a command to an electrical motor 340 to turn on and run in a forward direction. The control unit 600 may comprise a transceiver for receiving and sending electrical communications and computer logic to manage the operation of the camera mechanism 110. As illustrated in FIGS. 3, 4, 6 and 7, the electrical motor 340 may spin in a clockwise direction to produce the desired forward direction of the camera lens 150. (It should be noted, although not illustrated, that the motor 340, spur gear 300, and rack 320 may be placed in other arrangements where a counterclockwise rotation of the motor 340 may produce a forward direction of the camera lens 150.) The electrical motor 340 may be connected to a spur gear 300 so that the spur gear teeth 900 may also be rotated along with the motor 340 in either a clockwise or a counterclockwise direction.

The spur gear teeth 900 may be positioned to mesh with the teeth 1000 of a rack 320, so that the rotation of the spur gear teeth 900 may produce a linear motion of the rack 320. A camera bracket 200 may be attached to the rack 320 so that the camera bracket 200 moves with the rack 320. A camera 210 and/or a camera lens 150 may be mounted to the camera bracket 200 and thus the camera 210 and/or camera lens 150 moves along with the camera bracket 200. Thus, the electric motor 340, depending on the direction of spin produced by the electric motor 340, may control the direction of the movement of the camera 210 and/or camera lens 150.

Once a desired picture or video is needed, the motor 340 may spin in the appropriate direction to push the camera lens 150 through the aperture 130, make contact with the aperture cover attached to the inside of the cooking chamber 120 and move the aperture cover to an open position so that the camera lens 150 has an unobstructed view of one or more food items being cooked in the cooking chamber 120. (Step 1410)

Once the camera lens 150 is within the cooking chamber 120, the camera mechanism 110 may take pictures and/or videos of the food items cooking in the cooking chamber 120 in real-time. (Step 1420) The camera mechanism 110 may transmit the pictures/video of the food items cooking to the client device 1100 in real time. (Step 1430) After the picture/video have been taken, the camera mechanism 110 may send a command to the electrical motor 340 to run in a reverse direction so as to remove or withdraw the camera lens 150 from the cooking chamber 120 which may also automatically close the aperture cover over the aperture 130. (Step 1440)

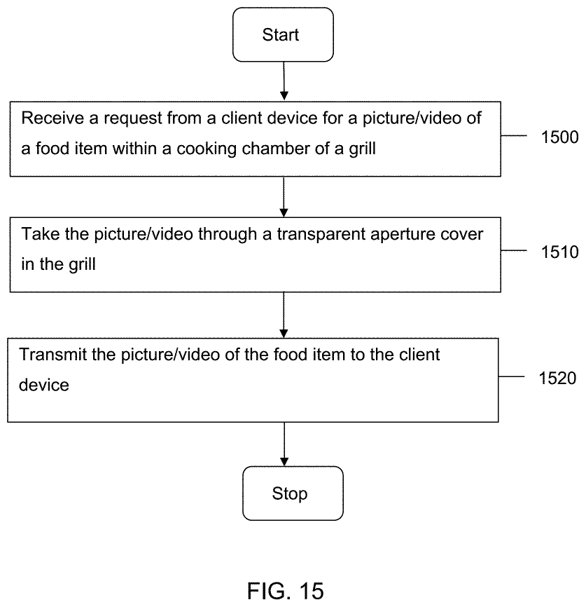

Another method of practicing the invention is illustrated in FIG. 15. In this embodiment, the aperture 130 may be considered to be open or covered with a transparent aperture cover 230. As before, the control unit 600 of the camera mechanism 110 may receive a command or determine that a picture or video is requested by the user. (Step 1500).

The camera lens 150 may be fixedly mounted to the side of the grill 100 so as to view the food items through the aperture 130 and possibly through a transparent aperture cover 230. The camera mechanism 110 may take the picture/video of the food items in the cooking chamber 120. (Step 1510) A transceiver within the camera mechanism 110 may transmit the picture or video of the food cooking in the cooking chamber 120 to the client device 1100 in real-time. (Step 1520) This allows the user to instantly see the food items in real-time as the food items cook within the cooking chamber 120 without the user having to travel to the grill 100 and without the user opening the grill 100 which may undesirably lower the temperature inside the grill 100.

In some embodiments, the grill 100 may also have a thermometer configured to measure a temperature within the cooking chamber 120 or the food item. The current temperature may be periodically transmitted to the client device 1100 or the user may request from time to time the temperature within the cooking chamber 120 or the food item as desired.

In some embodiments, the control unit 600 may be configured to automatically remove the camera lens 150 from within the cooking chamber 120 upon reaching a predefined condition. The predefined condition may be, as non-limiting examples, if the cooking chamber 120 gets too hot or the camera lens 150 is left for too long of a period with the cooking chamber 120. Either of this conditions may damage the camera lens 150 and/or the camera mechanism 110.

Another embodiment is illustrated in FIG. 20. As previously described, the camera mechanism 110 may receive a request from the client device 1100 for a picture or video. (Step 2000) The camera mechanism 110 may determine whether it is save for the various parts of the camera mechanism to take the picture or video. (Step 2010) This may be accomplished by measuring the temperature in the cooking chamber 120, measuring the temperature of some part of the camera mechanism 110 or determining that some part of the camera mechanism 110 has been in the cooking chamber 120 for too long and/or at too high of a temperature (too high of a duty cycle). If it is safe for the camera mechanism 110 to take the picture or video, the picture or video may be taken by the camera mechanism 110 (Step 2020) and transmitted to the client device (Step 2030). On the other hand, if the control unit 600 of the camera mechanism 110 determines it is not safe for some part of the camera mechanism 110 to take the picture or video, the camera mechanism 110 may transmit a message to the client device 1100 that the camera mechanism 110 is not able to take a real-time picture or video of the food items cooking in the cooking chamber 120 at this time, preferably with a detailed description of the problem and preferably what corrective action is needed and/or when a picture or video might be taken at a later time. (Step 2040) If a previous picture or video is in the memory of the control unit 600, the camera mechanism 110 may transmit this previous picture or video to the client device (Step 2030) with a notification that this is a previous picture or video.

In some embodiments, the control unit 600 may be configured to receive a turn-off command from the client device 1100 and, triggered by the turn-off command, disable the heat source 140 of the grill 100 in real-time. This allows the user to remotely turn the grill 100 off, once the food items have finished cooking.

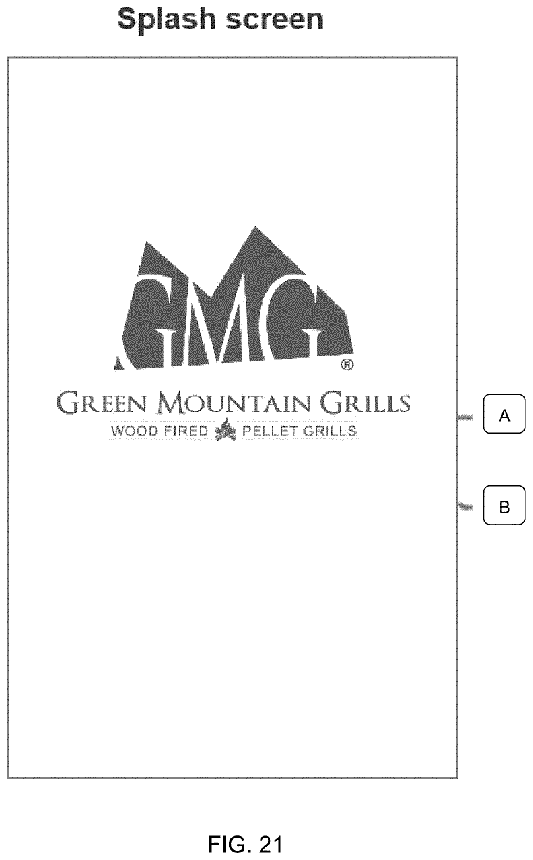

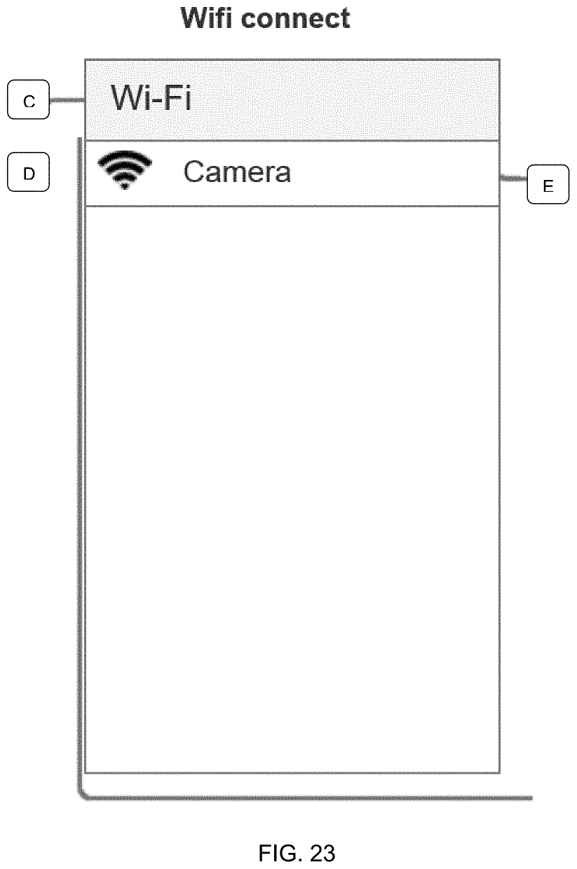

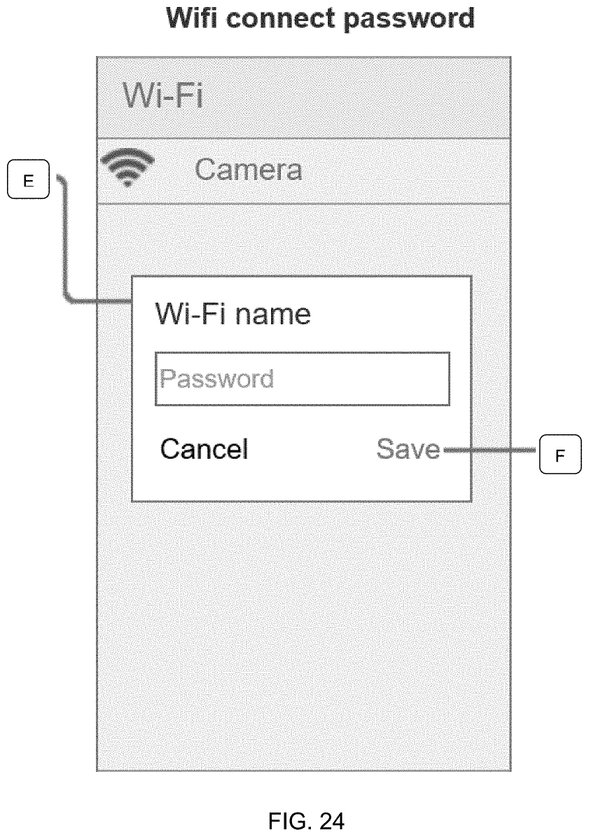

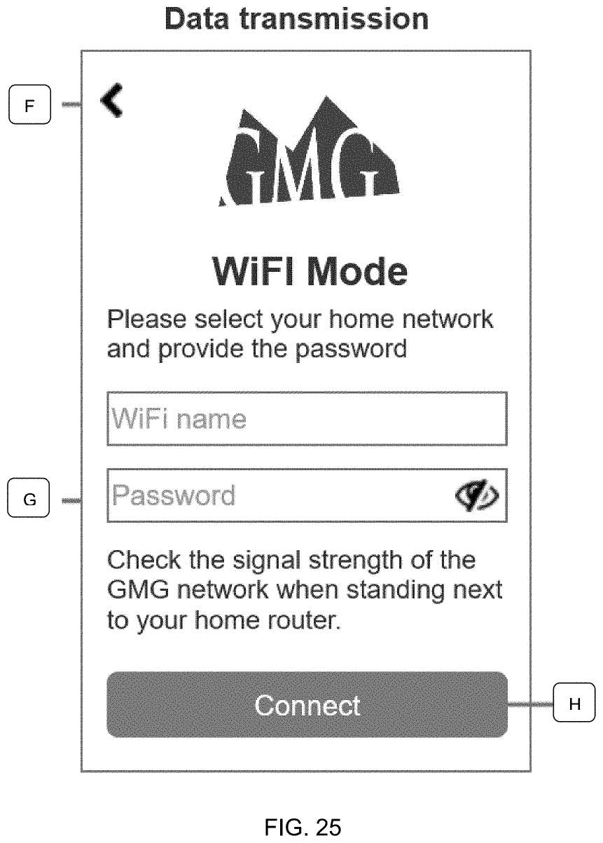

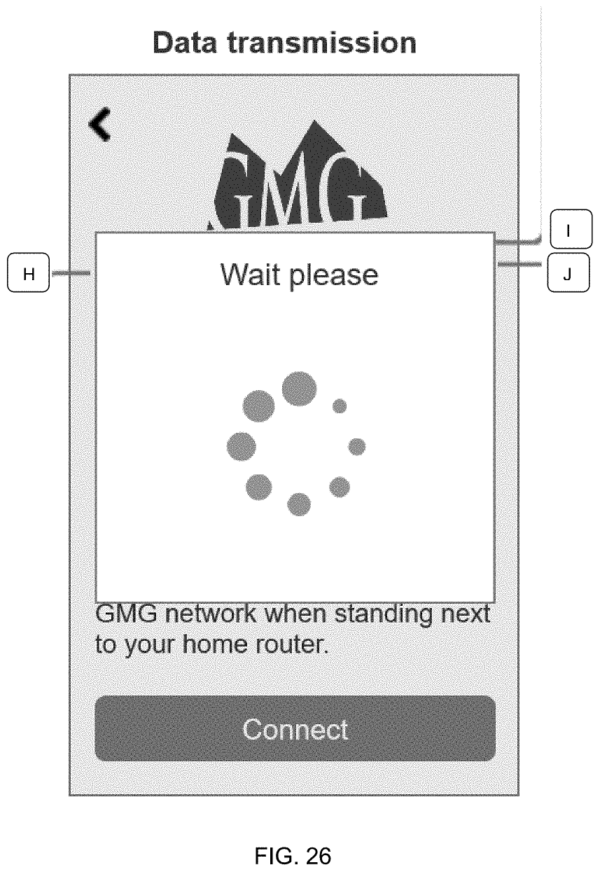

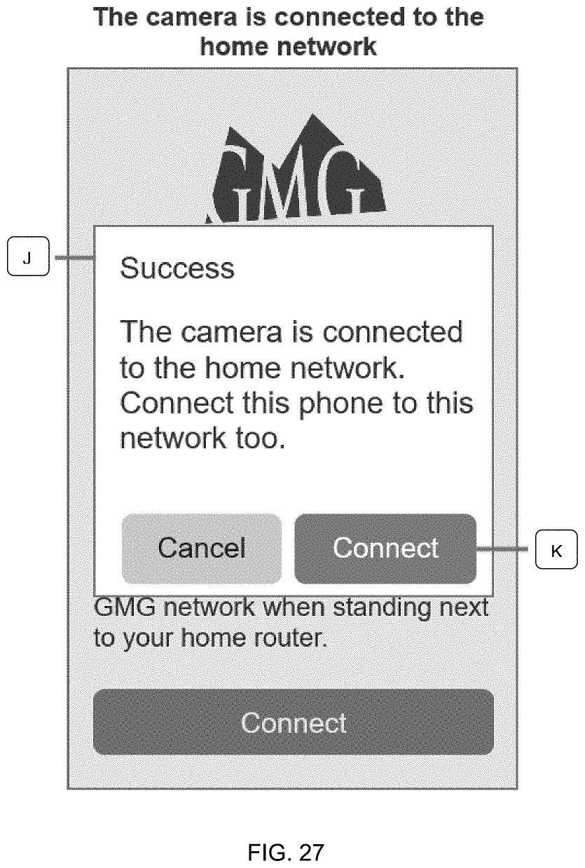

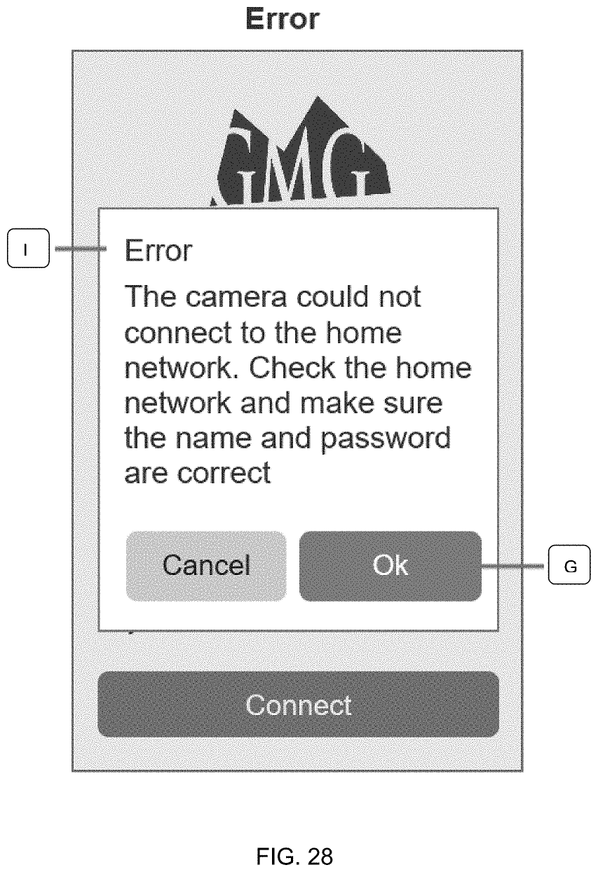

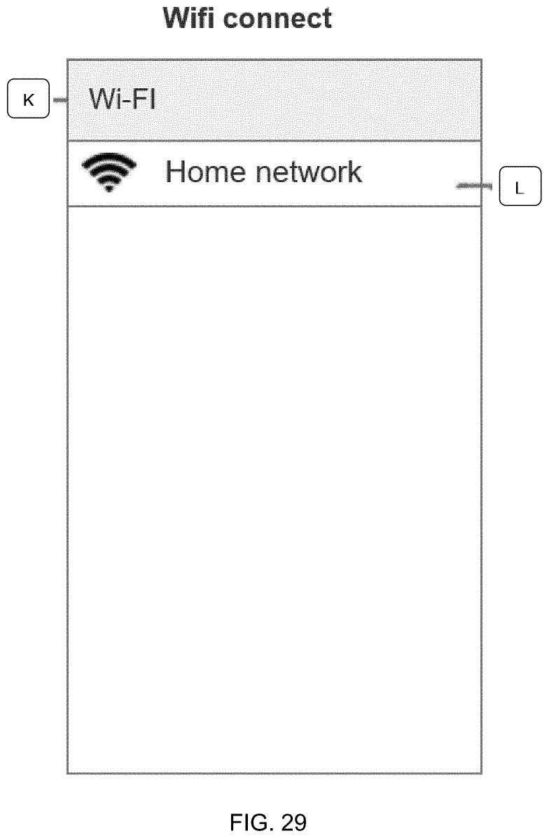

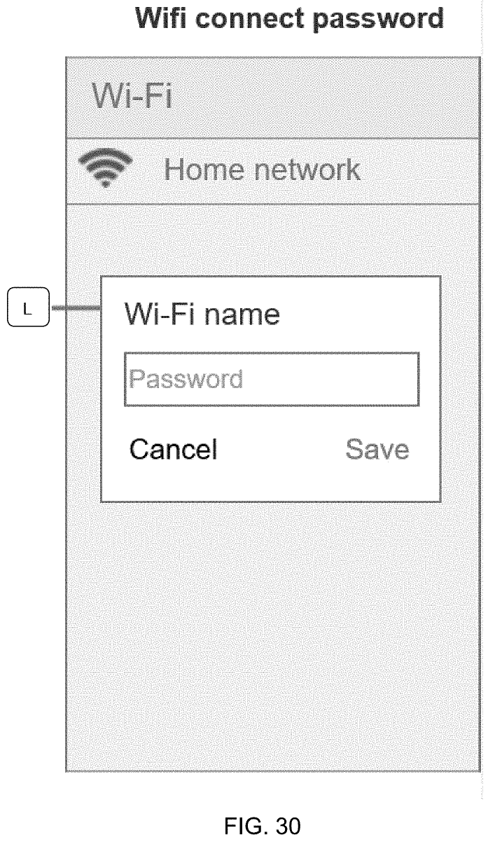

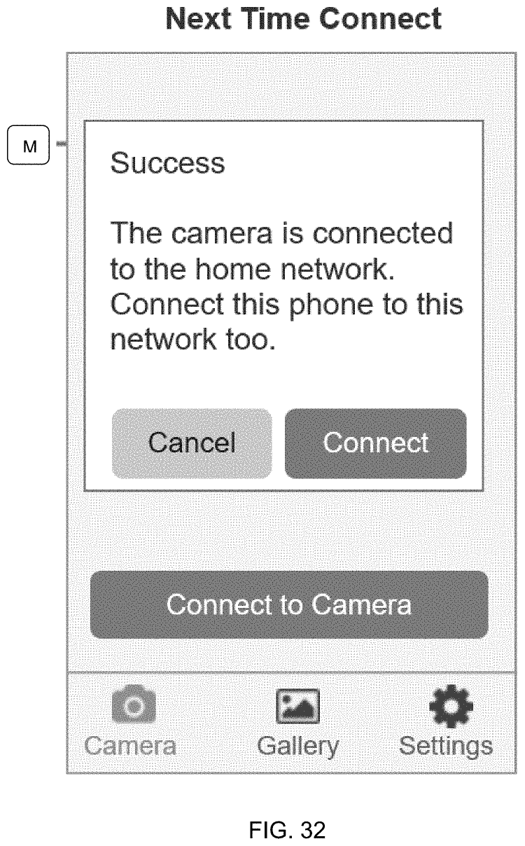

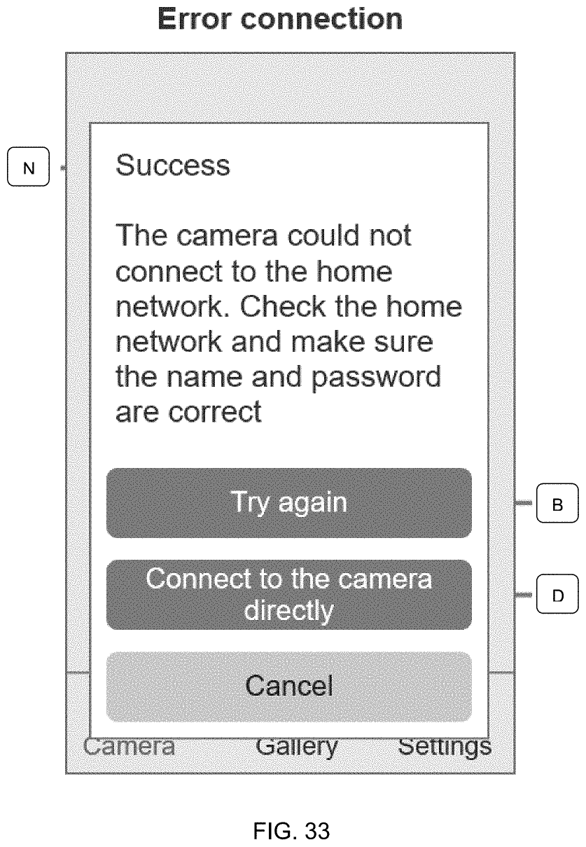

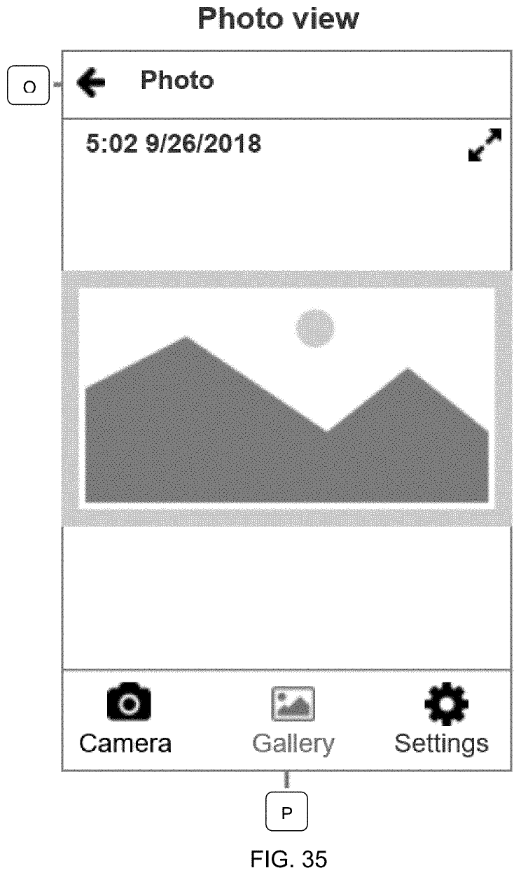

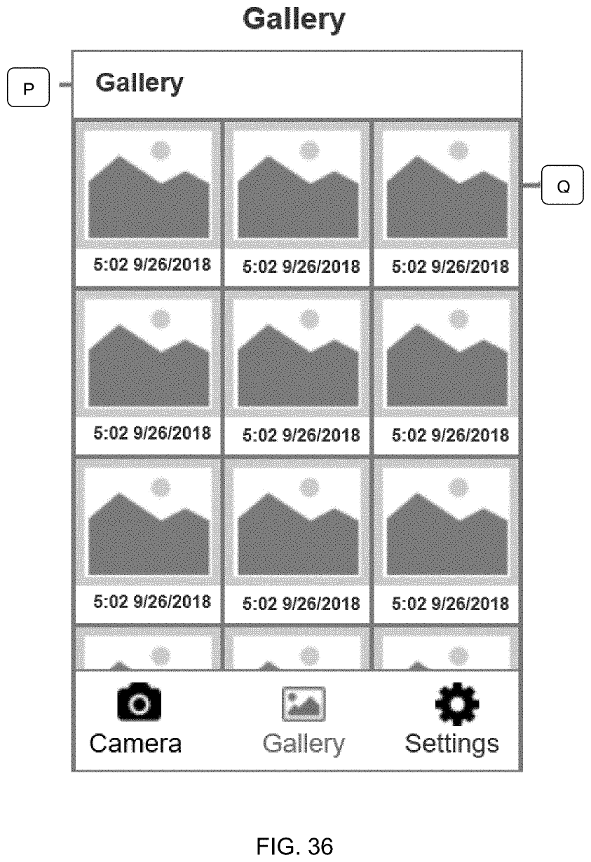

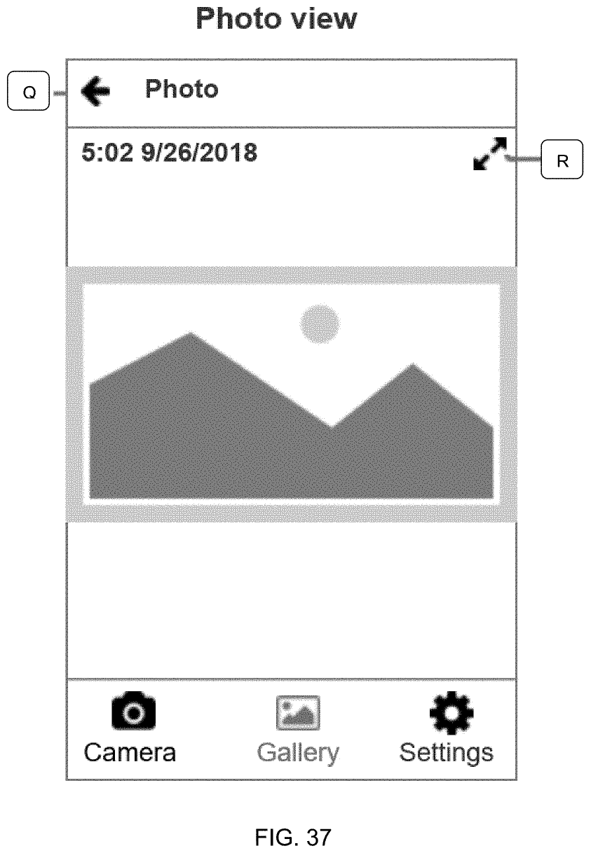

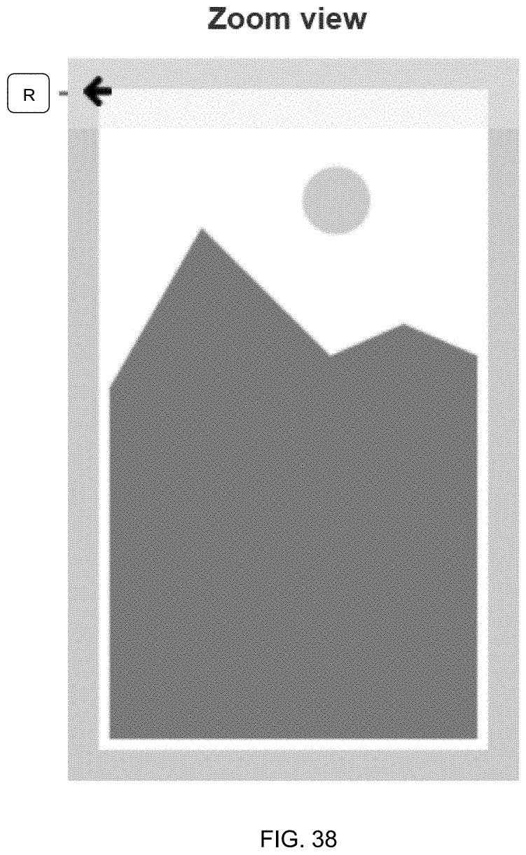

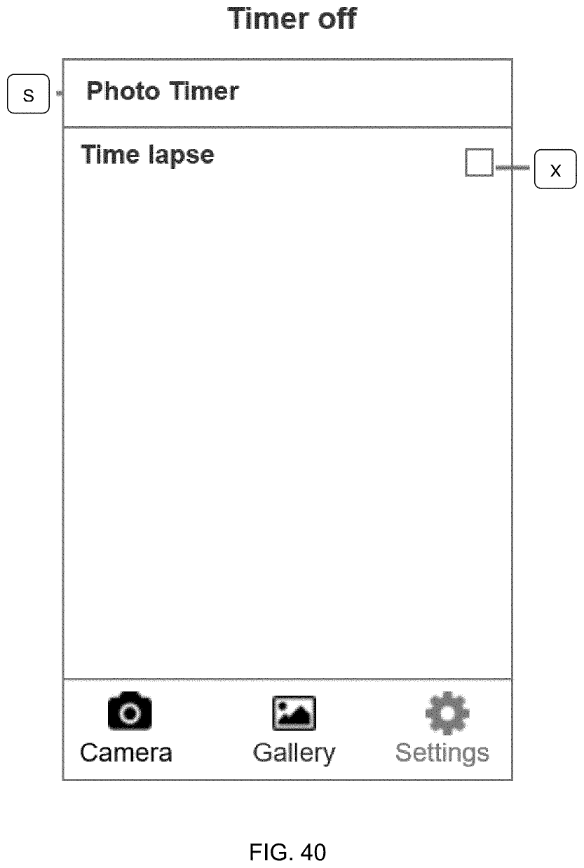

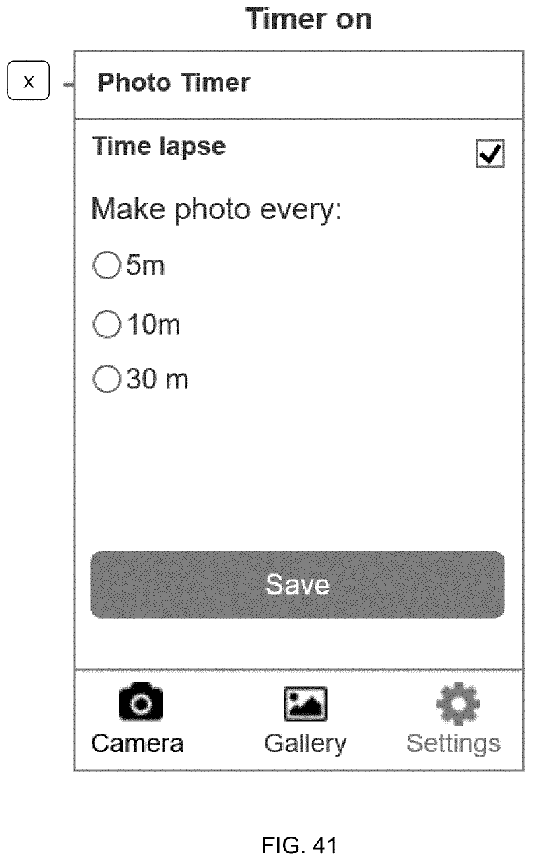

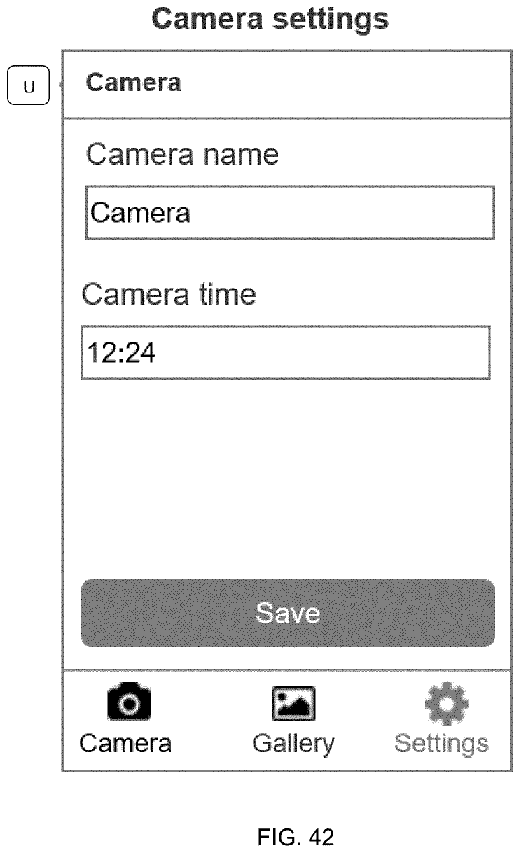

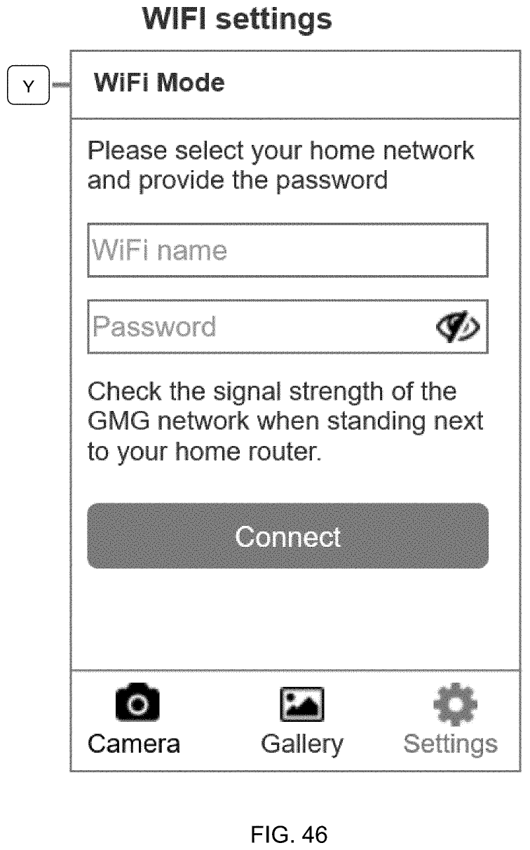

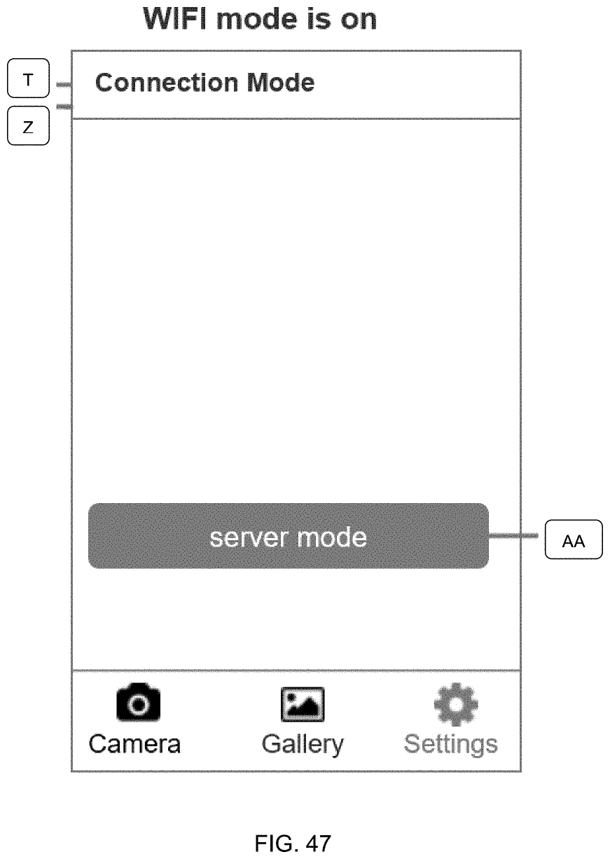

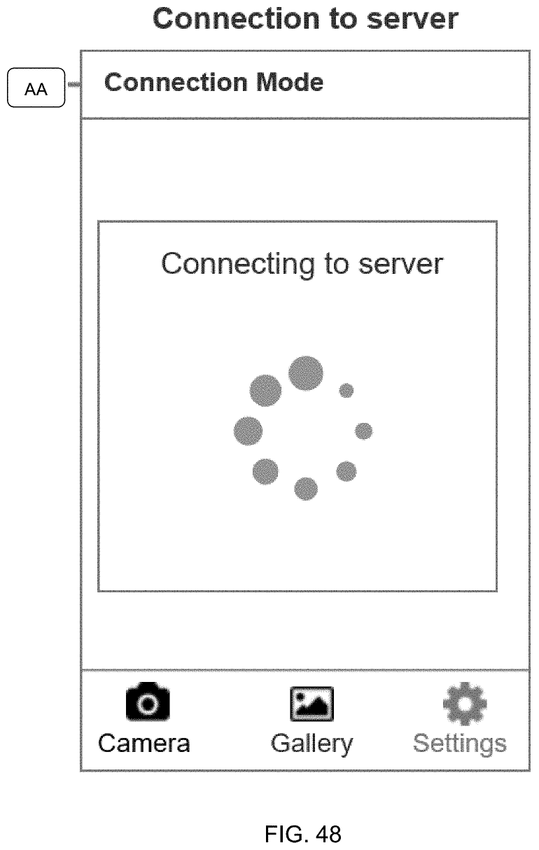

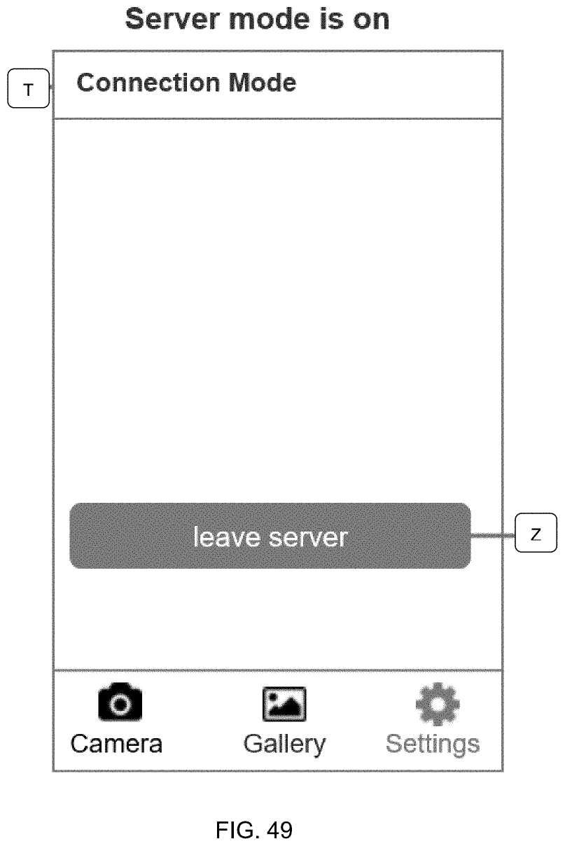

In some embodiments, an application may be stored on a server connected to the Internet and downloaded to the client device 1100. As non-limiting examples, the application may be stored in the Apple App Store or any other App store. The application may then be run on the client device 1100 to assist the user in controlling the camera mechanism 110. FIGS. 21-49 are example screens that may be displayed to the user on the client device 1100 so that the user may remotely control the camera mechanism 110.

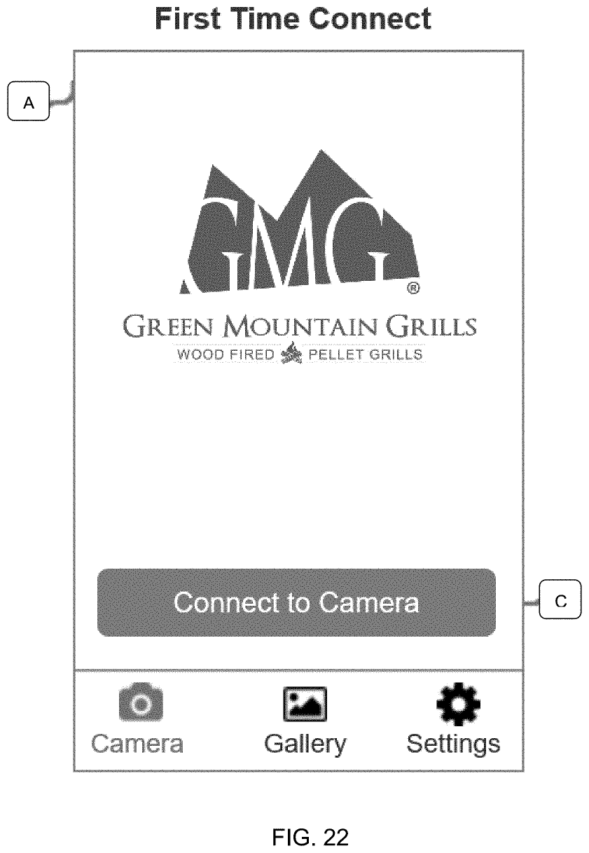

FIG. 21 is an example of a splash screen that may be displayed on the client device 1100 for use by the user. FIGS. 22-30 are example screens that may be displayed and used to assist the user in connecting the imaging device (camera) and the client device (cell phone or computer) of the user to a WiFi network.

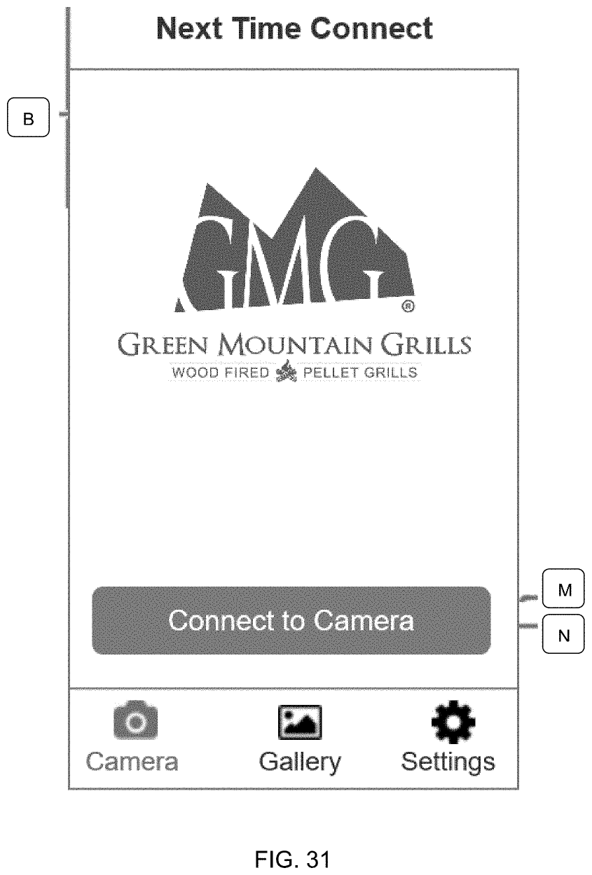

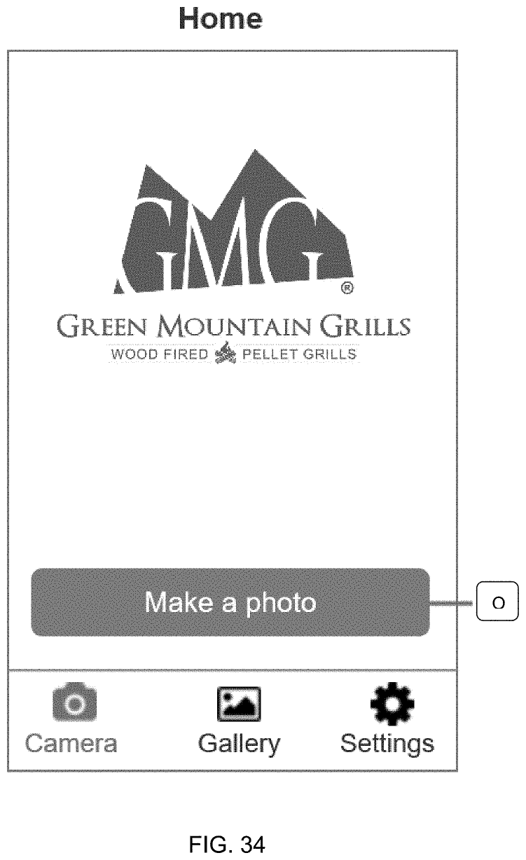

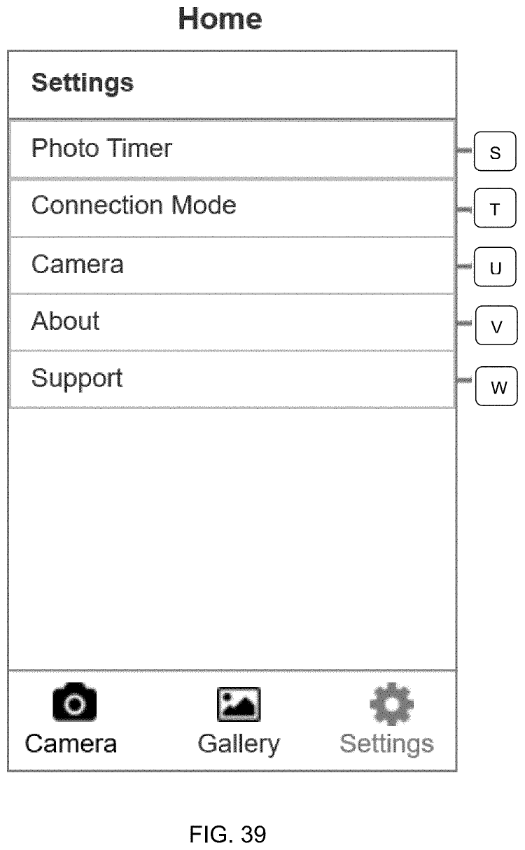

FIGS. 31-33 are example screens that may be used to assist the user after the WiFi connections for the imaging device and the client device have been established. FIGS. 34-38 are example screens that may be used to take and view one or more photographs and/or videos of the inside the grill. FIGS. 39-42 are example screens that may be used to periodically take one or more photographs and/or videos of the inside of the grill.

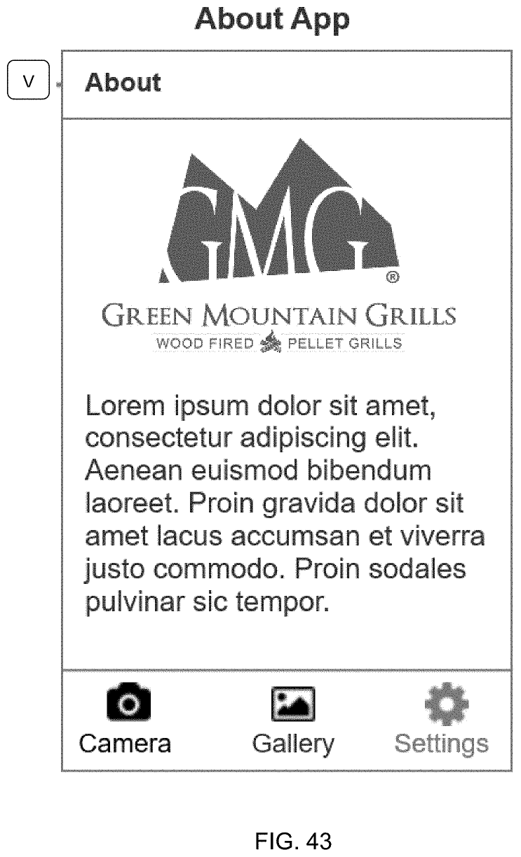

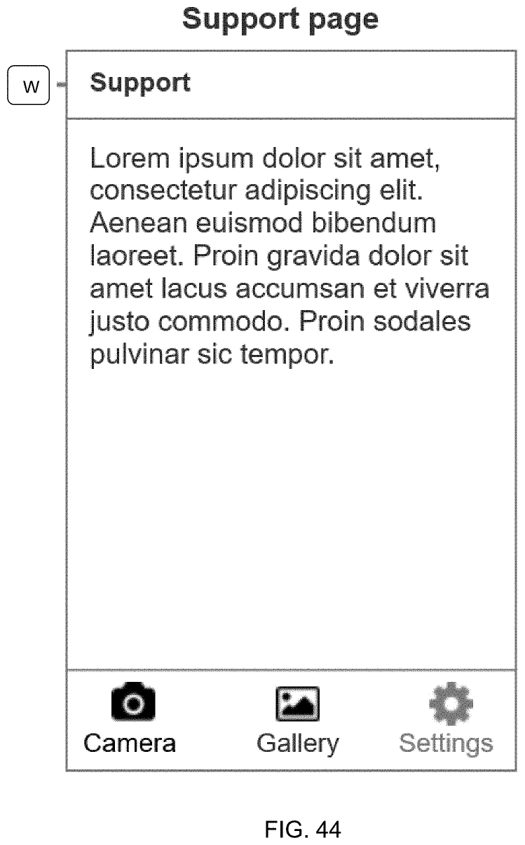

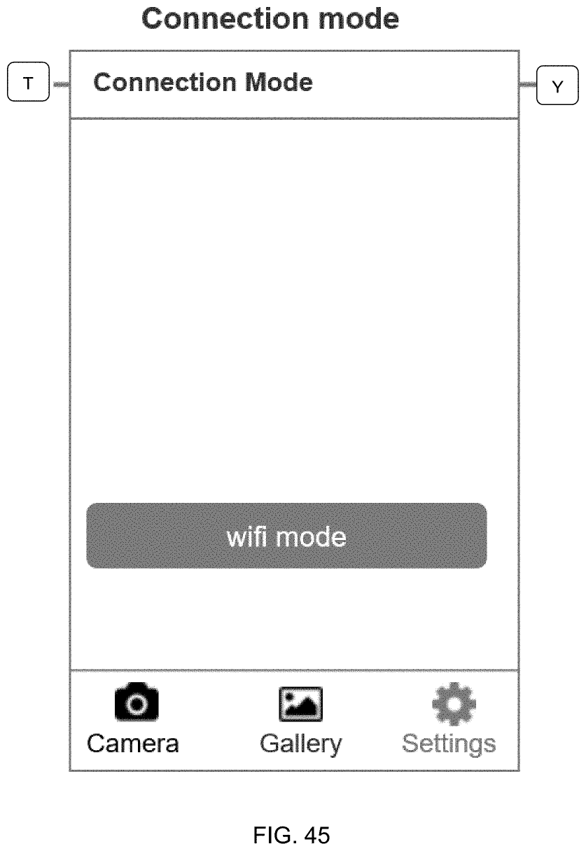

FIG. 43 is an example of an about application screen that may be used to inform the user about the use of the present invention. FIG. 44 is an example support page that may be used to inform the user about support matters, such as online resources that may be referenced on the Internet. FIGS. 45-49 are example screens that may be used by the user to connect to a server.

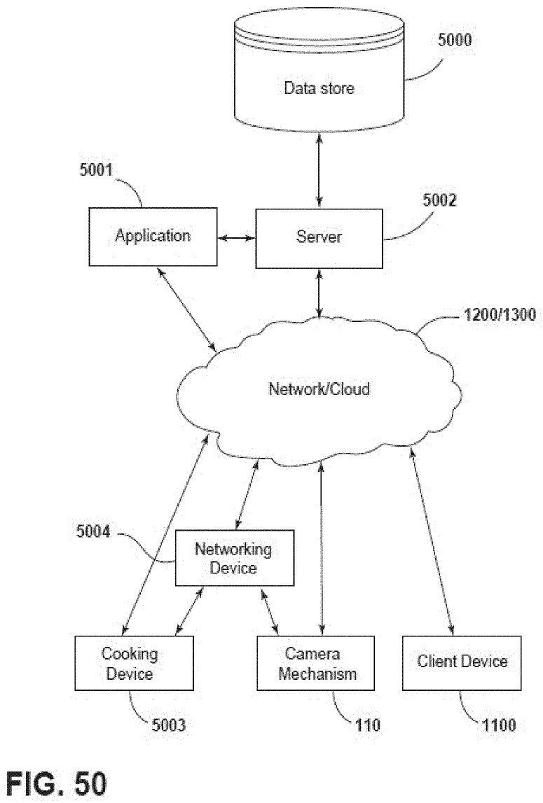

Referring to FIG. 50, in some examples, the cooking device 5003 and/or the camera mechanism 110 may be communicatively coupled with one or more remote sites such as a remote server 5002 via a network/cloud 1200/1300. The network/cloud 1200/1300 represents one or more systems by which the cooking device 5003 and/or the camera mechanism 110 may communicate with the remote server 5002. Accordingly, the network/cloud 1200/1300 may be one or more of various wired or wireless communication mechanisms, including any desired combination of wired and/or wireless communication mechanisms and any desired network topology (or topologies when multiple communication mechanisms are utilized). Exemplary communication networks 1200/1300 include wireless communication networks (e.g., using Bluetooth, IEEE 802.11, etc.), local area networks (LAN) and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 1200/1300 in FIG. 50). The verbal image has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not exactly the same, these terms are generally used interchangeably herein, and they may be referred to collectively as the network/cloud 1200/1300.

The server 5002 may be one or more computer servers, each of which may include at least one processor and at least one memory, the memory storing instructions executable by the processor, including instructions for carrying out various steps and processes. The server 5002 may include or be communicatively coupled to a data store 5000 for storing collected data as well as instructions for operating the cooking device 5003, the camera mechanism 110, etc. that may be directed to and/or implemented by the cooking device 5003 and/or the camera mechanism 110 with or without intervention from a user and/or the client device 1100. Further, the server 5002 may store information related to multiple cooking devices 5003, food items, usage characteristics, errors, etc. and operate the cooking device 5003 and/or the camera mechanism in conjunction with the stored information with or without intervention from a user and/or the client device 1100.

With further reference to FIG. 50, the server 5002 also generally implements features that may enable the cooking device 5003 and/or the camera mechanism 110 to communicate with cloud-based applications 5001. Communications from the cooking device 5003 and/or the camera mechanism 110 can be directed through the network/cloud 1200/1300 to the server 5002 and/or cloud-based applications 5001 with or without a networking device 5004, such as a router and/or modem. Additionally, communications from the cloud-based applications 5001, even though these communications may indicate one of the cooking device 5003 and/or the camera mechanism 110 as an intended recipient, can also be directed to the server 5002. The cloud-based applications 5001 are generally any appropriate services or applications 5001 that are accessible through any part of the network/cloud 1200/1300 and may be capable of interacting with the cooking device 5003 and/or the camera mechanism 110.

In various examples, the client device 1100 can be feature-rich with respect to communication capabilities, i.e. have built in capabilities to access the network/cloud 1200/1300 and any of the cloud-based applications 5001 or can be loaded with, or programmed to have, such capabilities. The client device 1100 can also access any part of the network/cloud 1200/1300 through industry standard wired or wireless access points, cell phone cells, or network nodes. In some examples, users can register to use the remote server 5002 through the client device 1100, which may provide access to the cooking device 5003 and/or the camera mechanism 110 and/or thereby allow the server 5002 to communicate directly or indirectly with the cooking device 5003 and/or the camera mechanism 110. In various instances, the cooking device 5003 and/or the camera mechanism 110 may also communicate directly, or indirectly, with the client device 1100 or one of the cloud-based applications 5001 in addition to communicating with or through the server 5002. According to some examples, the cooking device 5003 and/or camera mechanism 110 can be preconfigured at the time of manufacture with a communication address (e.g. a URL, an IP address, etc.) for communicating with the server 5002 and may or may not have the ability to upgrade or change or add to the preconfigured communication address.

Referring still to FIG. 10, when a new cloud-based application 5001 is developed and introduced, the server 5002 can be upgraded to be able to receive communications for the new cloud-based application 5001 and to translate communications between the new protocol and the protocol used by the cooking device 5003 and/or the camera mechanism 110. The flexibility, scalability and upgradeability of current server technology renders the task of adding new cloud-based application protocols to the server 5002 relatively quick and easy.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. An apparatus with a movable aperture cover for cooking and viewing a food item, comprising:
a grill, wherein the grill comprises:
a cooking chamber configured to receive and cook the food item,
a heat source configured to adjust the temperature within the cooking chamber,
an aperture through the cooking chamber,
an aperture cover movably mounted on the cooking chamber to cover the aperture, wherein the aperture cover is configured to be moved between a closed position that covers the aperture and an open position that leaves the aperture open; and
a camera mechanism mounted on the grill, wherein the camera mechanism comprises:
a camera bracket,
a camera mounted on the camera bracket, wherein the camera has a camera lens configured to be positioned outside the cooking chamber and adjacent to the aperture or inside the cooking chamber and extended through the aperture,
an electrical motor configured to move the camera lens between an outside position outside the cooking chamber and adjacent to the aperture and an inside position inside the cooking chamber and extended through the aperture, and
a control unit comprising a wireless transceiver and computer logic, wherein the control unit is configured to receive commands from a client device, transmit commands to the electronic motor, transmit data to the client device, receive a still picture or a video from the camera and transmit the still picture or the video to the client device.

2. The apparatus of claim 1, wherein the camera mechanism further comprises:
a spur gear connected to the electrical motor so that the spur gear is configured to rotate spur gear teeth in either a clockwise direction or a counterclockwise direction; and
a rack having rack teeth, wherein the rack teeth mesh with the spur gear teeth so that the rack is configured to move in a forward linear direction or a reverse linear direction depending on the rotation direction of the spur gear teeth.

3. The apparatus of claim 1, wherein the wireless transceiver is configured to communicate directly with the client device.

4. The apparatus of claim 1, wherein the wireless transceiver is configured to communicate with the client device through a local area network.

5. The apparatus of claim 1, wherein the wireless transceiver is configured to communicate with the client device through the Internet.

6. The apparatus of claim 1, wherein the grill further comprises:
a thermometer configured to measure a temperature within the cooking chamber or the food item, and
the control unit is configured to:
receive a request from the client device for the temperature,
read the temperature from the thermometer and
transmit the temperature to the client device.

7. The apparatus of claim 1, wherein the control unit is configured to transmit a video of the food item cooking in the cooking chamber in real-time to the client device.

8. The apparatus of claim 1, wherein the control unit is configured to automatically remove the camera lens from within the cooking chamber upon reaching a predefined condition.

9. The apparatus of claim 1, wherein the control unit is configured to receive a turn-off command from the client device and, triggered by the turn-off command, disable the heat source in real-time.

10. A method for monitoring a cooking of a food item in a grill, comprising the steps of:
receiving by a control unit, comprising a wireless transceiver and computer logic, a request from a client device for a picture or a video of the food item within a cooking chamber of the grill to be transmitted to the client device;
engaging, based on the request, an electrical motor in a forward direction that:
moves a camera lens of a camera from an outside position through an aperture in the cooking chamber to an inside position, and
moves an aperture cover from a closed position covering the aperture to an open position not covering the aperture, thereby resulting in an unobstructed view of the food item in the cooking chamber by the camera lens;
taking the picture or the video of the food item in the cooking chamber using the camera lens;
transmitting by the control unit the picture or the video of the food item to the client device in real-time; and
engaging the electrical motor in a reverse direction after taking the picture that:
moves the camera lens of the camera from the inside position through the aperture in the cooking chamber to an outside position outside of the cooking chamber, and
moves the aperture cover from the open position not covering the aperture to a close position covering the aperture, thereby thermally sealing the cooking chamber and protecting the camera lens from a heat of the cooking chamber.

11. The method of claim 10, wherein the wireless transceiver is configured to communicate directly with the client device.

12. The method of claim 10, wherein the wireless transceiver is configured to communicate with the client device through a local area network.

13. The method of claim 10, wherein the wireless transceiver is configured to communicate with the client device through the Internet.

14. The apparatus of claim 10, further comprising the steps of:
receiving, by the control unit, a turn-off command from the client device, and
triggered by receiving the turn-off command from the client device, immediately disabling the heat source in real-time.

15. An apparatus with a transparent aperture cover for cooking and viewing a food item, comprising:
a grill, wherein the grill comprises:
a cooking chamber configured to receive and cook the food item,
a heat source configured to adjust the temperature within the cooking chamber,
an aperture through the cooking chamber,
an aperture cover fixedly mounted on the cooking chamber to cover the aperture, wherein the aperture cover is substantially transparent; and
a camera mechanism mounted on the grill, wherein the camera mechanism comprises:
a camera bracket,
a camera mounted on the camera bracket, wherein the camera has a camera lens configured to be positioned outside the cooking chamber and adjacent to the aperture, and
a control unit comprising a wireless transceiver and computer logic, wherein the control unit is configured to receive commands from a client device, transmit data to the client device, receive a still picture or a video from the camera and transmit the still picture or the video to the client device.

16. The apparatus of claim 15, wherein the wireless transceiver is configured to communicate directly with the client device.

17. The apparatus of claim 15, wherein the wireless transceiver is configured to communicate with the client device through a local area network.

18. The apparatus of claim 15, wherein the wireless transceiver is configured to communicate with the client device through the Internet.

19. The apparatus of claim 15, wherein the control unit is configured to transmit a video of the food item cooking in the cooking chamber in real-time to the client device.

20. The apparatus of claim 15, wherein the control unit is configured to receive a turn-off command from the client device and triggered by the turn-off command, disable the heat source in real-time.
